(19) United States
(12) Patent Application Publication
(10) Pub. No.: US 2026/0065204 A1
(43) Pub. Date: Mar. 5, 2026

(54) INFORMATION PROCESSING SYSTEM AND METHOD FOR PROCESSING INFORMATION

(71) Applicant: FRONTEO, Inc., Tokyo (JP)

(72) Inventors: Toru HISAMITSU, Tokyo (JP); Yuichi KICHIKAWA, Tokyo (JP)

(21) Appl. No.: 19/018,886

(22) Filed: Jan. 13, 2025

(30) Foreign Application Priority Data
Sep. 2, 2024 (JP) 2024-151028

(51) Int. Cl. G06Q 10/0637; G06Q 40/06

(52) U.S. Cl. CPC G06Q 10/0637; G06Q 40/06

(57) ABSTRACT

An information processing system includes: an entity network obtaining unit configured to obtain an entity network representing a capital investment relationship between a plurality of nodes; and a controlled node identifying unit configured to identify a controlled node that is a node to be effectively controlled by a controlling node, wherein, when the controlling node and the controlled node that has been identified are set as a first node group, the controlled node identifying unit performs update processing to identify the controlled node, the update processing adding, to the controlled node, a node, directly connected to a second node group included in the first node group, and having capital contribution ratios including the capital contribution ratio and each assigned to an edge between the node and each of the nodes of the second node group, and a sum of the capital contribution ratios being greater than a first threshold.

### CROSS-REFERENCE TO RELATED APPLICATION

The present application claims priority from Japanese Application JP 2024-151028, filed Sep. 2, 2024, the content of which is hereby incorporated by reference into this application.

### BACKGROUND OF THE INVENTION

### 1. Field of the Invention

The present invention relates to, but not limited to, an information processing system and a method for processing information.

### 2. Description of the Related Art

A conventionally known technique utilizes a stock holding ratio(a shareholding ratio and a capital contribution ratio) to quantify and evaluate how influential an entity is on an other entity.

Examples of the entities include countries, companies, and people.

Mizuno T, Doi S, and Kurizaki S (2020) suggest a technique in “The power of corporate control in the global ownership network. PLOS ONE 15(8): e0237862. https://doi.org/10.1371/journal.pone.0237862”. That is, if an entity has an indirect influence on an other entity, the technique simply integrates shareholding ratios to quantify the influence.

Furthermore, Japanese Patent No. 7121366 proposes a technique; that is, if the capital contribution ratio is more than 50%, the technique rewrites the capital contribution ratio to read 100%, and quantify an influence between the entities.

### SUMMARY OF THE INVENTION

The conventional techniques could cause a deviation between an effective control relationship among the entities and a value of the influence to be calculated.

Aspects of the present disclosure set out to provide an information processing system and a method for processing information to appropriately evaluate an effective control relationship between entities.

An aspect of the present disclosure relates to an information processing system including: an entity network obtaining unit that obtains an entity network representing a capital investment relationship between a plurality of nodes each corresponding to one of a plurality of entities, the entity network including a lower node receiving an investment and a higher node making an investment, and the lower node and the higher node being connected together with an edge provided with a capital contribution ratio; and a controlled node identifying unit that identifies, in accordance with the entity network, a controlled node that is a node to be effectively controlled by a controlling node among the plurality of nodes. When the controlling node and the controlled node that has been identified are set as a first node group, the controlled node identifying unit performs update processing to identify the controlled node, the update processing adding, to the controlled node, a node included the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.

An other aspect of the present disclosure relates to a method for processing information performed by an information processing device. The method includes: obtaining an entity network representing a capital investment relationship between a plurality of nodes each corresponding to one of a plurality of entities, the entity network including a lower node receiving an investment and a higher node making an investment, and the lower node and the higher node being connected together with an edge provided with a capital contribution ratio; and identifying, in accordance with the entity network, a controlled node that is a node to be effectively controlled by a controlling node among a plurality of nodes. When the controlling node and the controlled node that has been identified are set as a first node group, the identifying the controlled node involves performing update processing to identify the controlled node, the update processing adding, to the controlled node, a node included in the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.

### BRIEF DESCRIPTION OF THE DRAWINGS

FIG. 1 illustrates an exemplary configuration of a system including an information processing system;

FIG. 2 illustrates an exemplary configuration of a server system;

FIG. 3 illustrates an exemplary configuration of a terminal device;

FIG. 4 is a graph illustrating a company ownership stake network analysis;

FIG. 5 is an example of an entity network (a subnetwork);

FIG. 6A is a graph illustrating a comparative example of this embodiment;

FIG. 6B is a graph illustrating a comparative example of this embodiment;

FIG. 7 is a specific example of a network in which an influence level of a comparative example is calculated excessively low;

FIG. 8 is a flowchart showing processing executed on an information processing system of this embodiment;

FIG. 9 is a flowchart showing processing to identify a controlled node;

FIG. 10 is a graph showing how control propagates in the processing to identify a controlled node;

FIG. 11 is a graph showing how control propagates in the processing to identify a controlled node;

FIG. 12 is a graph showing how control propagates in the processing to identify a controlled node;

FIG. 13 is a graph showing how control propagates in the processing to identify a controlled node;

FIG. 14 is a graph showing how control propagates in the processing to identify a controlled node;

FIG. 15A is an other example of an entity network (a subnetwork);

FIG. 15B is an example of an incidence matrix;

FIG. 16 is a flowchart showing processing using a matrix operation;

FIG. 17A illustrates tables showing a first step of vector update processing;

FIG. 17B is a graph showing an example of a result of the processing at the first step;

FIG. 18A illustrates tables showing a second step of the vector update processing;

FIG. 18B is a graph showing an example of a result of the processing at the second step;

FIG. 19A illustrates tables showing a third step of the vector update processing;

FIG. 19B is a graph showing an example of a result of the processing at the third step;

FIG. 20A illustrates tables showing a fourth step of the vector update processing;

FIG. 20B is a graph showing an example of a result of the processing at the fourth step;

FIG. 21A illustrates tables showing processing to calculate an influence level;

FIG. 21B is a graph showing an example of a result of the influence level calculation processing;

FIG. 22A illustrates tables showing a first step of vector update processing;

FIG. 22B is a graph showing an example of a result of the processing at the first step;

FIG. 23A illustrates tables showing a second step of the vector update processing;

FIG. 23B is a graph showing an example of a result of the processing at the second step;

FIG. 24A illustrates tables showing processing to calculate an influence level;

FIG. 24B is a graph showing an example of a result of the influence level calculation processing;

FIG. 25 is a graph showing an example of a result of processing according to this embodiment; and

FIG. 26 is a graph showing an example of a result of processing according to this embodiment.

### DETAILED DESCRIPTION OF THE INVENTION

An embodiment will be described with reference to the drawings. Throughout the drawings, identical or equivalent constituents will be denoted by the same signs, and the description of redundancies about such constituents will be omitted. Note that this embodiment described below will not unduly limit the features recited in the claims. Furthermore, not all of the configurations described in this embodiment are necessarily essential constituent features of the present disclosure.

### 1. OSINT System

### 1.1 Exemplary Configuration of System

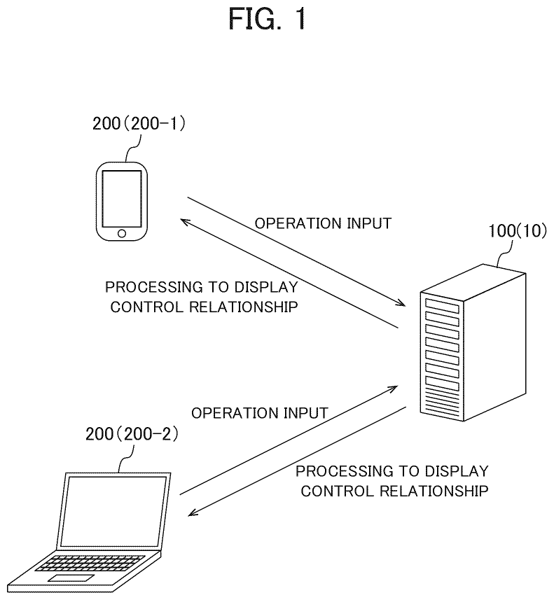

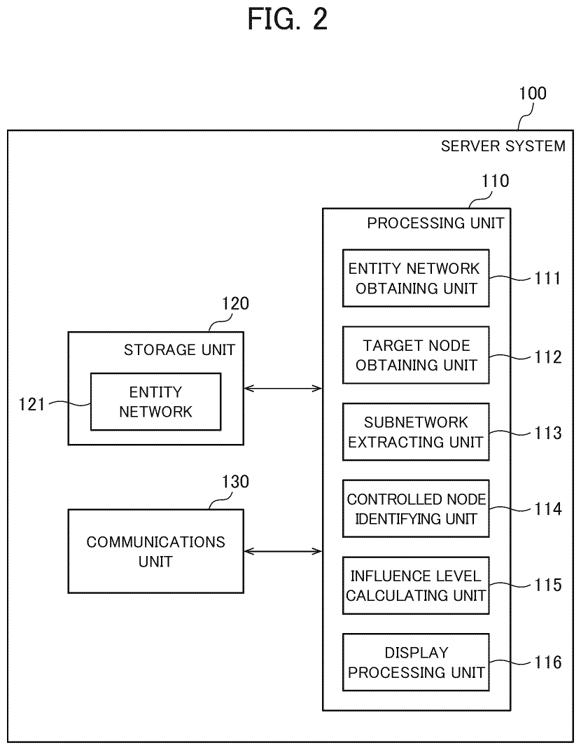

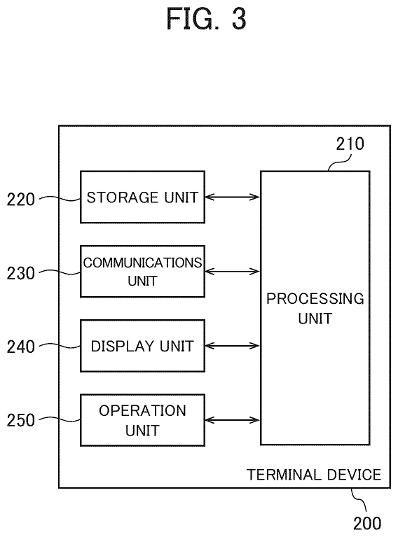

FIG. 1 is an exemplary configuration of a system including an information processing system 10 according to this embodiment. The system according to this embodiment includes: a server system 100; and a terminal device 200. Note that a configuration of the system including the information processing system 10 shall not be limited to the example illustrated in FIG. 1. The configuration can be subjected to various modifications, such as either omitting a portion of the configuration or adding an other configuration. For example, FIG. 1 illustrates the terminal device 200 including two terminal devices such as a terminal device 200-1 and a terminal device 200-2. However, the terminal device 200 may include any given number of terminal devices. Furthermore, the same applies to FIGS. 2 and 3 to be mentioned later, where modifications, such as omission and addition of constituent elements, can be made.

The information processing system 10 of this embodiment corresponds to, for example, the server system 100. Moreover, the server system 100 corresponds to a computer. Note that the technique in this embodiment shall not be limited to the foregoing: the information processing system 10 may execute processing through distributed processing by the use of the server system 100 and an other device. For example, the information processing system 10 according to this embodiment may be implemented through distributed processing on the server system 100 and terminal device 200. Described below will be an example in which the information processing system 10 is the server system 100.

The server system 100 may be a single server or may include a plurality of servers. For example, the server system 100 may include a database server and an application server. The database server may store various data items including an entity network 121 to be described later. The application server may perform various kinds of processing according to this embodiment. The plurality of servers may be physical servers or virtual servers. If virtual servers are used, the virtual servers may be provided to a single physical server or distributed among a plurality of physical servers. As described above, the specific configuration of the server system 100 according to this embodiment can be modified in various manners.

The terminal device 200 is a device that is used by a user who uses the information processing system 10. The terminal device 200 may be a personal computer (PC), a mobile terminal device such as a smartphone, or any other device.

The server system 100 is connected to the terminal device 200-1 and terminal device 200-2 over, for example, a network. Hereinafter, the terminal device 200-1 and the terminal device 200-2 will be simply referred to as the terminal device 200 unless the terminal devices have to be distinguished from each other. The network is, for example, a public communications network such as the Internet. Alternatively, the network may also be a local area network (LAN).

The information processing system 10 of this embodiment is an open-source intelligence (OSINT) system for, but not limited to, collecting and analyzing data related to a target by the use of, for example, open information. The open information includes various kinds of information widely accessible and legally available, such as securities reports, inter-industry relations tables, governments' official announcements, and reports on countries and companies. Note that the information processing system 10 of this embodiment shall not be limited to the OSINT system.

The server system 100 generates nodes including various attributes according to the open information. A node represents an entity. The entity may be a person, a company, or a country. An attribute is, for example, information to be determined according to the open information. The attribute includes information on the entity and information on a shareholding ratio(a capital contribution ratio). The attribute may also include various kinds of information such as a nationality, a business field, sales, the number of employees, board members, and traded goods.

If an attribute of a given node includes an attribute including a relationship with an other node, the given node and the other node are connected with an edge having a direction. For example, suppose a case where a shareholder of a given entity includes an other entity. In this case, a node corresponding to the other entity and a node corresponding to the given entity are connected with an edge representing a shareholding ratio. The edge is an edge having a direction from an influencing entity to an influenced entity. For example, the edge is an edge having a direction from an investing entity to an invested entity. Note that the edge may have a direction from an influenced entity to an influencing entity.

With a technique of this embodiment, the server system 100 obtains an entity network; that is, a network in which a plurality of nodes representing a plurality of entities is connected together with edges each having a direction based on an attribute. That is, the entity network is a directed graph. The server system 100 conducts an analysis based on the entity network, and performs processing to present a result of the analysis. For example, the terminal device 200 is a device that is used by a user who uses a service provided by the OSINT system. For example, the user uses the terminal device 200 to request the server system 100 (the information processing system 10) to conduct an analysis of some kind. The server system 100 conducts an analysis based on the entity network, and transmits, as a response, a result of the analysis to the terminal device 200.

FIG. 2 is a block diagram illustrating an example of a detailed configuration of the server system 100. The server system 100 includes, for example: a processing unit 110; a storage unit 120; and a communications unit 130.

The processing unit 110 of this embodiment can be implemented in the form of predetermined hardware. The hardware can include at least one of a digital-signal processing circuit or an analog-signal processing circuit. For example, the hardware can include one or more circuit devices, or one or more circuit elements, mounted on a circuit board. Examples of the circuit devices include an integrated circuit (IC) and a field-programmable gate array (FPGA). Examples of one or more circuit elements include a resistor and a capacitor.

The processing unit 110 may be implemented in the form of one or more processors. The server system 100 of this embodiment includes, for example, a memory that stores information, and a processor that operates according to the information stored in the memory. Examples of the information include a program and various kinds of data. The processor includes hardware. The processor can be various kinds of processors such as a central processing unit (CPU), a graphics processing unit (GPU), and a digital signal processor (DSP). The memory may be a semiconductor memory such as a static random access memory (SRAM), a dynamic random access memory (DRAM), or a flash memory; alternatively, the memory may be a resistor. The memory may be a magnetic storage device such as a hard disk drive (HDD); alternatively, the memory may be an optical storage device such as an optical disc device. For example, the memory stores a computer-readable instruction, which is executed by the processor to thus implement the function of the processing unit 110 as processing. The instruction may be a set of instructions constituting the program, or an instruction for instructing a hardware circuit of the processor to operate.

The processing unit 110 in the example of FIG. 2 includes: an entity network obtaining unit 111; a target node obtaining unit 112; a subnetwork extracting unit 113; a controlled node identifying unit 114; an influence level calculating unit 115; and a display processing unit 116.

The entity network obtaining unit 111 is an obtaining unit to obtain the entity network 121. For example, the entity network obtaining unit 111 may generate the entity network 121 according to open information. The entity network obtaining unit 111 stores the generated entity network 121 in the storage unit 120. When executing processing of this embodiment including processing to identify a controlled node, the entity network obtaining unit 111 performs processing to read (obtain) the entity network 121 stored in the storage unit 120.

The entity network 121 may be generated by an other system that is different from the information processing system 10 according to this embodiment. In this case, the entity network obtaining unit 111 may obtain the entity network from an other system through the communications unit 130.

The entity network obtaining unit 111 obtains, as the entity network 121, for example, a network in which a plurality of entities is connected together with a capital investment relationship. The entity network 121 includes a plurality of entities. Each of the entities represents a node, as described above. The nodes are connected together with edges in accordance with the capital investment relationship. Furthermore, each of the edges is provided with a capital contribution ratio. The capital contribution ratio represents a shareholding ratio. The information on the shareholding ratio can also be obtained in accordance with the open information described above.

The target node obtaining unit 112 performs processing to obtain a target node from the plurality of nodes included in the entity network 121. Here, the target node represents a node to be a target for obtaining an influence level from an other node. For example, the target node obtaining unit 112 may obtain the target node in accordance with a result of an operation executed on the terminal device 200 to select the target node.

When any one of the plurality of nodes in the entity network 121 is determined as the target node, the subnetwork extracting unit 113 performs processing to extract a subnetwork including a higher node to be directly or indirectly connected to the target node.

Note that it is not essential to extract the subnetwork related to the target node. For example, the extracted subnetwork may be related not to the target node; that is, a node to be controlled, but to a node to control (i.e., a controlling node to be described below). Furthermore, the extraction of the subnetwork per se may be omitted, and the processing below may be executed for the entire entity network. In addition, various modifications can be made to a sequence of specific processing. Mainly described below will be an example of obtaining a target node, extracting a subnetwork related to the target node, and performing processing for the subnetwork.

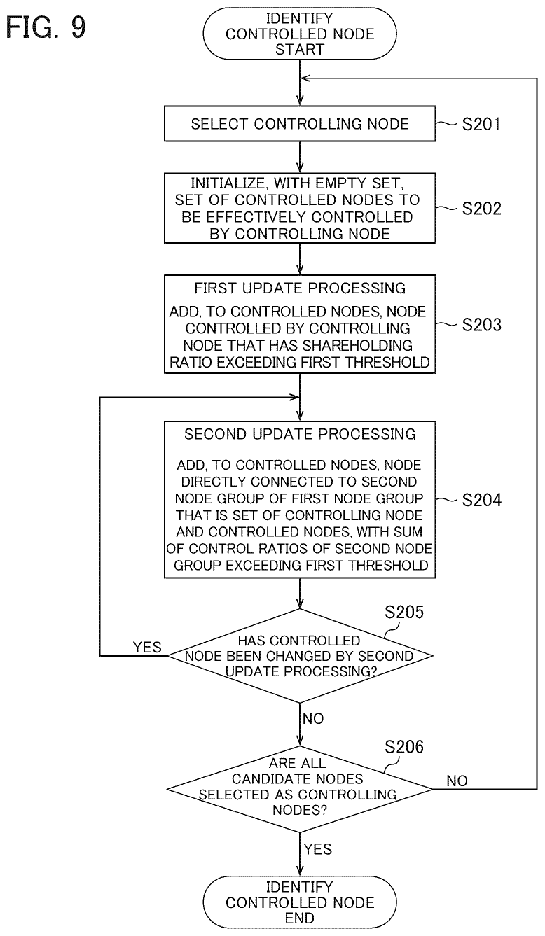

The controlled node identifying unit 114 performs: processing to select from a subnetwork a controlling node that effectively controls an other node; and processing to identify a controlled node that is a node effectively controlled by the controlling node. Here, the effective control means that the behavior of an other entity can be substantially controlled. For example, if an entity can determine how an other entity acts in accordance with the capital investment relationship, the entity effectively controls the other entity. More specifically, the action here is an action based on a resolution of the other entity. For example, the effective control may indicate that a decision can be made to accept and/or reject the resolution. In this case, the effective control over the other entity may be to directly or indirectly hold a majority of stocks with voting rights, which are issued by the other entity. The processing on the controlled node identifying unit 114 will be described later with reference to, for example, FIGS. 9 to 14. Note that, in the entity network 121, each node corresponds to an entity, and a control relationship between entities is referred to as a control relationship between nodes. That is, in this Specification, a statement “an entity corresponding to a controlling node effectively controls an entity corresponding to a controlled node” is simply described as “a controlling node effectively controls a controlled node”. Likewise, a node in the description below shall not be limited to a node per se in a network (in a directed graph), and may represent an entity corresponding to the node.

The influence level calculating unit 115 calculates an influence level that is an index indicating an influence level of the controlling node on an other node. The influence level in this embodiment is an index value taking: a maximum value (e.g., 1) if the target node is a controlled node; a minimum value (e.g., 0) if the target node is not directly connected to either a controlling node or a controlled node; and an intermediate value (e.g., more than 0 and less than 1) if the target node is not a controlled node and if an immediately upper node is either a controlling node or a controlled node. The intermediate value varies according to a control level. Note that this embodiment may concurrently use an other influence level such as an influence level disclosed in Japanese Patent No. 7121366 (hereinafter referred to as POWER INDEX).

The display processing unit 116 performs processing to cause a display unit to display a result of the processing performed in this embodiment. Here, the display unit is, for example, a display unit 240 of the terminal device 200. Note that a display target of the display processing unit 116 may be either a display unit of the server system 100 or a display unit of an other device.

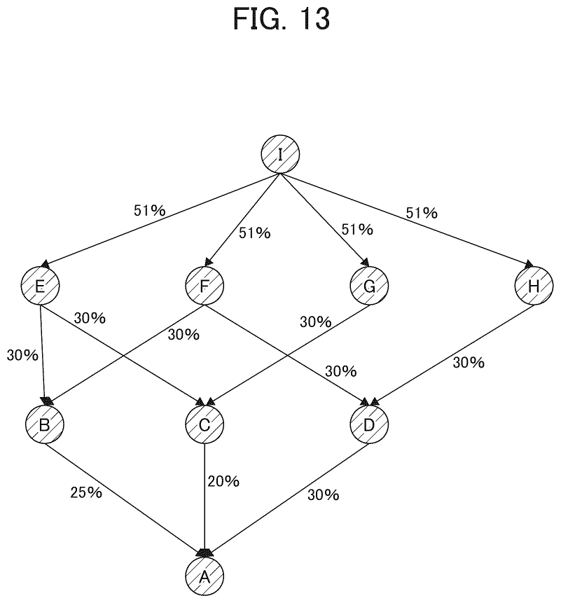

The display processing unit 116 performs, in the entity network, processing to display a controlling node and a controlled node in a manner distinguishable from an other node, The details will be described later with reference to, for example, FIGS. 13, 14, 25, and 26. Furthermore, the display processing unit 116 may perform either processing to display a screen including the influence level calculated by the influence level calculating unit 115, or processing to display an other index value such as an indirect shareholding ratio or POWER INDEX.

The storage unit 120 is a working area of the processing unit 110, and stores various kinds of information. The storage unit 120 can be implemented in the form of various kinds of memories. The memories may be semiconductor memories such as an SRAM, a DRAM, a ROM, and a flash memory. The memories may be registers, magnetic storage devices such as a hard disk drive, and optical storage devices such as an optical disc device.

The storage unit 120 stores the entity network 121 obtained by, for example, the entity network obtaining unit 111. The storage unit 120 can store various kinds of information for the processing to be executed in this embodiment.

The communications unit 130 is an interface for communications over a network. The communications unit 130 includes, for example: an antenna; a radio frequency (RF) circuit; and a baseband circuit. The communications unit 130 may operate in accordance with control of the processing unit 110, or include a communications controlling processor different from the processing unit 110. The communications unit 130 is, for example, an interface for performing communications in accordance with the transmission control protocol/Internet protocol (TCP/IP). The specific communications scheme can be modified in various manners.

FIG. 3 is a block diagram illustrating an example of a detailed configuration of the terminal device 200. The terminal device 200 includes: a processing unit 210; a storage unit 220; a communications unit 230; the display unit 240; and an operation unit 250.

The processing unit 210 is hardware including at least one of a digital-signal processing circuit or an analog-signal processing circuit. The processing unit 210 may be implemented in the form of a processor. The processor can be various kinds of processors, such as a CPU, a GPU, and a DSP. The processor executes an instruction stored in the memory of the terminal device 200, so that the function of the processing unit 210 is implemented in the form of processing.

The storage unit 220 is a working area of the processing unit 210, and is implemented in the form of various kinds of memories such as an SRAM, a DRAM, and a ROM.

The communications unit 230 is an interface for communications over a network. The communications unit 230 includes, for example: an antenna; an RF circuit; and a baseband circuit. The communications unit 230 communicates with the server system 100 over, for example, a network.

The display unit 240 is an interface to display various kinds of information. The display unit 240 may be a liquid crystal display, an organic EL display, or a display that operates under any other scheme. In accordance with the control from the display processing unit 116 of the server system 100, the display unit 240 displays, for example, a screen including an entity network in which a display mode of a controlling node and a controlled node is different from a display mode of other nodes.

The operation unit 250 is an interface for the user operating the terminal device 200. The operation unit 250 may be, for example, a button provided to the terminal device 200. The display unit 240 and the operation unit 250 may be combined together to constitute a touch panel.

### 1.2 Specific Example of Service

Described next will be a specific example of a service to be provided by the OSINT system; namely, the information processing system 10. Described below will be an example of a company ownership stake network analysis as a specific service.

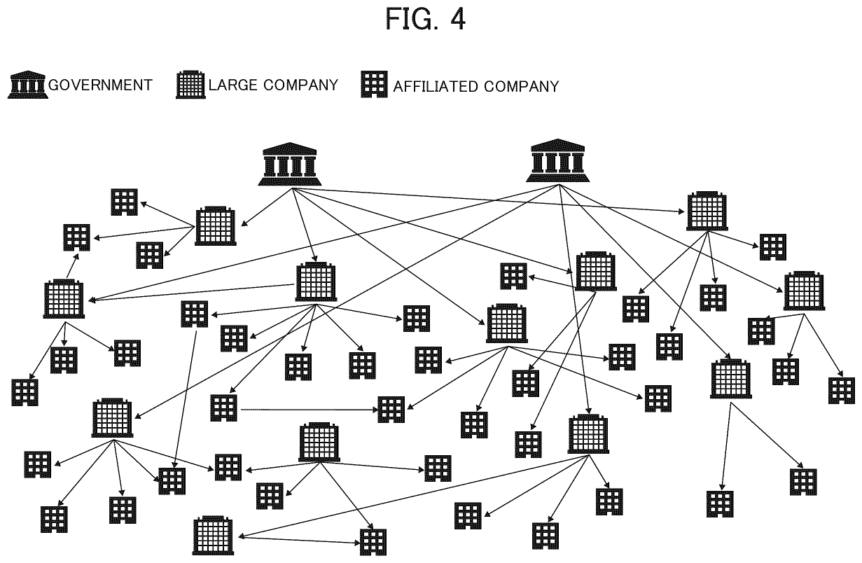

FIG. 4 is a graph illustrating a company ownership stake network analysis, which is an example of an entity network representing a capital investment relationship. As illustrated in FIG. 4, a network is formed to show capital investment relationships of countries and companies in accordance with information indicating shareholders and capital contribution ratios included in the open information.

For example, when designating any one of the nodes in a network to be processed as a controlling node, the controlled node identifying unit 114 identifies a controlled node to be effectively controlled by the controlling node. Furthermore, the influence level calculating unit 115 analyzes an influence level that various countries and companies have on other companies. In this case, the influence level represents a level of controlling power exercised by investment.

For example, if the controlling node is a specific country, either the controlled node identifying unit 114 obtains a controlled node effectively controlled by the controlling node or the influence level calculating unit 115 obtains an influence level that the controlling node has on a company in a given industry sector. Such a feature makes it possible to grasp to what degree the specific country controls product supplies in the industry sector. For example, when a serious incident occurs in the country, the feature makes it possible to evaluate influence that the incident has on a stable supply of the products. The controlled node identifying unit 114 and the influence level calculating unit 115 may determine whether each of the countries effectively controls a global company, or may obtain the influence of each country on the global company. Such a feature makes it possible to grasp a power balance between the countries. Furthermore, a time-series change in the influence on the global company is obtained for each of the countries. Such a feature makes it possible to grasp transition of the power balance.

Alternatively, the controlled node identifying unit 114 and the influence level calculating unit 115 may determine whether one country effectively controls a company related to an infrastructure of a given country, and may obtain the influence of the one country on the company. The company related to the infrastructure may be a company related to energy such as electric power, or may be a company providing a mobile communications network. Such a feature makes it possible to evaluate the risk that the infrastructure fails.

Alternatively, the controlled node identifying unit 114 and the influence level calculating unit 115 may determine whether one country effectively controls a company having a technology divertible to military use, and may obtain the influence of the one country on the company. Such a feature makes it possible to detect the risk of national security.

The controlled node identifying unit 114 and the influence level calculating unit 115 may obtain a change of a target to be effectively controlled, and variations in the influence level observed, when either a country or a company takes a specific action. For example, if a given country is assumed to change the foreign policies, such a feature makes it possible to obtain a range and an influence level of the effective control before and after the policy change, thereby successfully simulating the influence of the policy change on the countries of the world.

The controlled node identifying unit 114 and the influence level calculating unit 115 utilize the company ownership stake network analysis, thereby successfully conducting an analysis based on a complex capital investment relationship that is difficult to detect manually.

In recent years, relationships between countries, companies, and people have established more global and complex networks than ever before. Hence, manual analysis has a limit. In this regard, the OSINT system described above can analyze, for example, a network showing how companies are through investments. The OSINT system can interpret a complex relationship, and allows a government and a company to plan an optimal strategy.

### 2. Details of Processing

Described below will be details of the processing in this embodiment. A technique of this embodiment is a company ownership stake network analysis in a narrow sense. Note that the technique of this embodiment is applicable to any given technique other than the company ownership stake network analysis.

### 2.1 Index Representing Influence Level

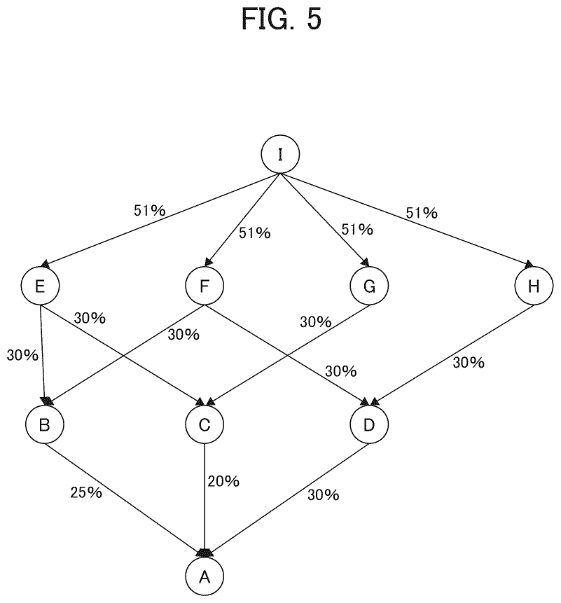

Examined first is an index representing an influence level. FIG. 5 is an example of either the entity network 121 obtained by the entity network obtaining unit 111, or a subnetwork to be extracted by the subnetwork extracting unit 113. The network of FIG. 5 includes nine nodes of a node A to a node I respectively corresponding to an entity A to an entity I. In FIG. 5, an edge of an arrow has: a tail connected to a node corresponding an investor (i.e., a higher node, or an upstream node); and a head connected to an investee (i.e., a lower node, or a downstream node).

In the network of FIG. 5, each of the nodes E, F, G, and H is connected to the node I with an edge. Each edge is associated with a numerical value of 51% representing a capital contribution ratio(i.e., a shareholding ratio). Hence, the entity I acquires more than 50% of the shares of each of the entities E to H, and thus effectively controls the entities E to H. Note that, as described above, for the sake of simplicity, the statement such as “the shareholding ratio of the entity I corresponding to the node I in the entity E corresponding to the node E is 51%” reads “the shareholding ratio of the node I in the node E is 51%”.

Furthermore, in the network of FIG. 5, the shareholding ratio of each of the node E and the node F in the node B is 30%. The shareholding ratio of each of the node E and the node G in the node C is 30%. The shareholding ratio of each of the node F and the node H in the node Dis 30%. The shareholding ratio of the node B in the node A is 25%. The shareholding ratio of the node C in the node A is 20%. The shareholding ratio of the node D in the node A is 30%.

For example, an indirect shareholding ratio, which is widely known, is determined in accordance with a product of shareholding ratios on a path connecting two nodes together. For example, a path of the node I→the node E→the node B→the node A is found between the node I and the node A. Hereinafter, a path between the nodes is referred to as, for example, a path IEBA by simply listing the node names. The shareholding ratios assigned to the edges on this path are 0.51, 0.30, and 0.25. Hence, the indirect holding ratio of the node I in the node A through the path IEBA is obtained by 0.51×0.30×0.25. Between the node I and the node A, another path is found. Hence, values are obtained for all the paths, and the obtained values of the paths are summed. Thus, the indirect shareholding ratios between the node I and the node A is determined.

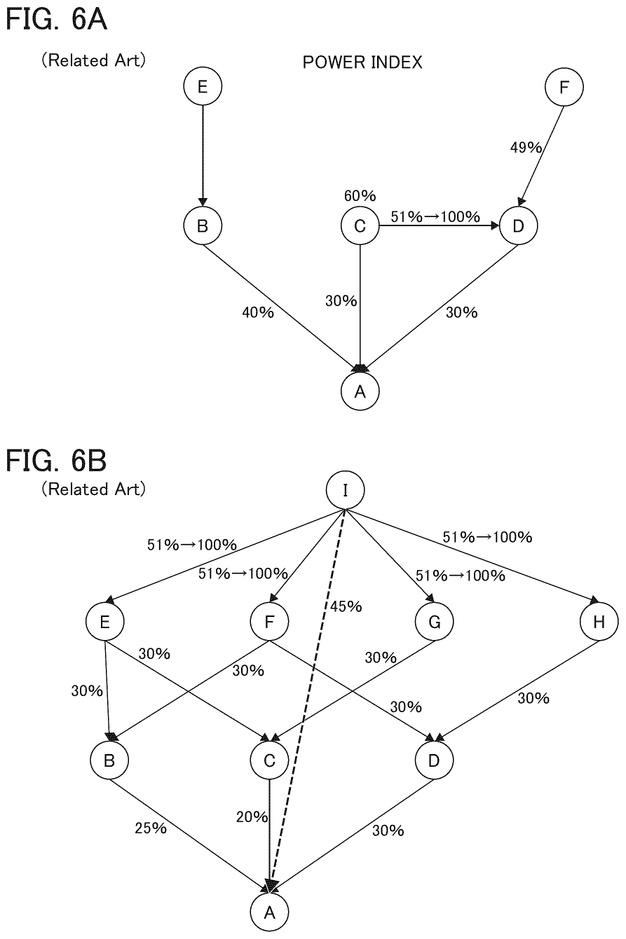

Furthermore, as to POWER INDEX disclosed in Japanese Patent No. 7121366, if the shareholding ratio exceeds 50%, the shareholding ratio is changed to 1, and then, the same calculation as that executed for the indirect shareholding ratio is executed. FIG. 6A is a graph illustrating a scheme disclosed in Japanese Patent No. 7121366. In the example of FIG. 6A, POWER INDEX of the node C with respect to the node A is examined. In this case, the shareholding ratio of the node C in the node D exceeds 50% such that the value is replaced with 1. Hence, POWER INDEX of the node C with respect to the node A is 0.60 (60%); that is, the sum of 0.30 on a path CA and 1×0.30 on a path CDA.

In the network of FIG. 6A, the node C holds more than 50% of the stocks of the node D, and thus effectively controls the node D. Thus, the node C is free to exercise 30% of the node A's shares directly held by the node C, and 30% of the node A's shares held by the node D. As described above, POWER INDEX is 60%, which is suitable as an index value indicating an influence level of the node C on the node A. In other words, compared with an indirect shareholding ratio prior to POWER INDEX, POWER INDEX is a value that reflects an actual influence level.

FIG. 6B is a graph illustrating an example in which the scheme disclosed in Japanese Patent No. 7121366 is applied to the network of FIG. 5. In this case, the shareholding ratio of the node I in each of the nodes E to H exceeds 50%, and each shareholding ratio is replaced with 1. Hence, the indirect shareholding ratio along the path IEBA is corrected to read 1×0.30×0.25. The same applies to the other paths. When the calculation is carried out for all the paths, POWER INDEX representing an influence level of the node I on the node A is 45%. In this case, POWER INDEX is 50% or less. Seemingly, the node I gives an impression of not effectively controlling the node A.

However, when the network of FIG. 6B (FIG. 5) is examined, such an interpretation is not necessarily correct. For example, in this network, the shareholding ratio of the node I in each of the nodes E to H exceeds 50%. Hence, the node I effectively controls the nodes E to H.

Furthermore, the shareholding ratio of each of the node E and the node F in the node B is 30%, and the node E and the node F are effectively controlled by the node I. This means that the node I holds more than 50% of the shares of the node B. That is, the node I effectively controls the node B. Likewise, the sum of the shareholding ratios of nodes, which are effectively controlled by the node I, in each of the node C and the node D is more than 50%. Hence, the node C and the node D are effectively controlled by the node I.

Then, the nodes B to D are effectively controlled by the node I, and a sum of the shareholding ratios of the three nodes in the node A is 75%. Thus, the node A is also effectively controlled by the node I. As can be seen, in the network of FIG. 6B (FIG. 5), the node I effectively controls the node A; however, POWER INDEX representing the influence level of the node I on the node A is a relatively small value.

The scheme of Japanese Patent No. 7121366 has an advantage; that is, if a shareholding ratio of one node in an other node is more than 50%, the value of the shareholding ratio is updated to read 1 so that POWER INDEX can reflect an effective control relationship. However, if a plurality of nodes collectively has a shareholding ratio of more than 50%, POWER INDEX is less likely to reflect an effective control relationship. For example, in FIG. 6B, the node E and the node F jointly hold 60% of the shares of the node B. However, an individual shareholding ratio does not exceed 50%. Thus, POWER INDEX is calculated without updating the value. Both of the nodes E and F are effectively controlled by the node I, and the nodes E and F can cooperate in a resolution for the node B. However, the scheme disclosed in Japanese Patent No. 7121366 fails to consider such a point.

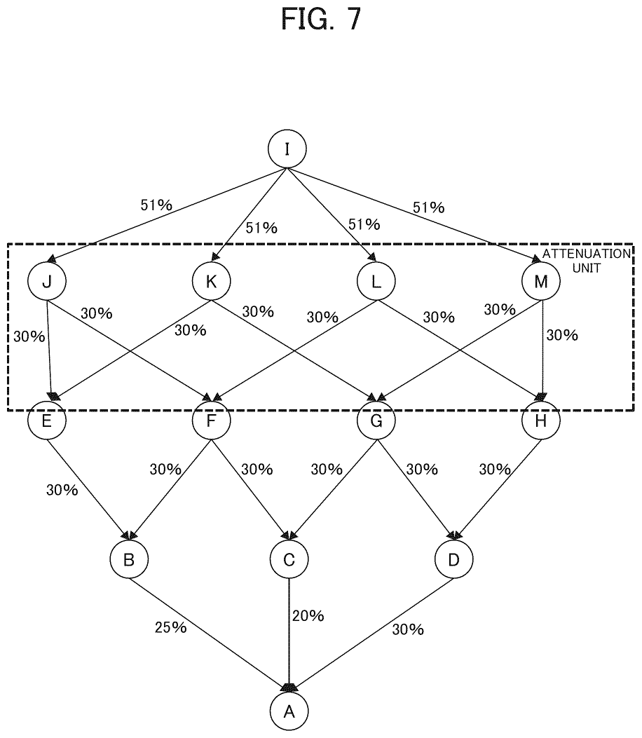

FIG. 7 is an other example of a network in which POWER INDEX is likely to be calculated lower than an actual influence level. In the network of FIG. 7, the node I effectively controls the nodes J to M. The shareholding ratios of two of the nodes J to M are summed so that the node I effectively controls the nodes E to H. Furthermore, the shareholding ratios of two of the nodes E to H are summed so that the node I effectively controls the nodes B to D. Then, as seen in the example of FIG. 6B, the shareholding ratios of the nodes B to D are summed so that the node I effectively controls the node A. As can be seen, also in the example of FIG. 7, the node I effectively controls the node A. However, downstream of the nodes J to M, the shareholding ratio assigned to each of the edges does not exceed 50%. Hence, the above relationship of effective control is failed to be considered, and POWER INDEX is calculated inevitably using the original value (30%). As a result, POWER INDEX representing the influence level of the node I on the node A is below 50%.

For example, FIG. 7 illustrates an attenuation unit that is a network structure in which the shareholding ratios of a plurality of nodes, effectively controlled by a specific node, are summed to exceed 50%. Here, in the network including the attenuation unit, the value of POWER INDEX is likely to be smaller than an actual influence level. In the example of FIG. 6B, the structure between the nodes E to H and the nodes B to D corresponds to the attenuation unit. Likewise, in the example of FIG. 6B, the structure between the nodes B to D and the node A corresponds to the attenuation unit. Furthermore, in the example of FIG. 7, the attenuation units are found in three stages between the nodes J to M and the nodes E to H, between the nodes E to H and the nodes B to D, and between the nodes B to D and the node A. Hence, the value of POWER INDEX is smaller in the network of FIG. 7 than in the network of FIG. 6B.

Whereas, as illustrated in FIG. 2, the information processing system 10 (e.g., the server system 100) according to this embodiment includes: the entity network obtaining unit 111; and the controlled node identifying unit 114. Then, when the controlling node and the controlled node that has been identified are set as a first node group, the controlled node identifying unit 114 performs update processing to identify the controlled node, the update processing adding, to the controlled node, a node included in the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.

Here, the controlling node represents a node that possibly controls an other node either in an entity network or in a subnetwork in accordance with a capital investment relationship (i.e., more specifically, a node that possibly controls a target node). The first node group is, as described above, a set of a controlling node and a node known to be effectively controlled by the controlling node. That is, the first node group is a set of a controlling node and a node cooperative with the controlling node when the controlling node attempts to exert influence on a certain company (e.g., when the controlling node attempts to exercise voting rights on a certain company).

Furthermore, in relation to any node excluded from the first node group, the second node group is a node included in the first node group and directly connected to the any node (i.e., a node directly above the any node; that is, a node positioned one stage upstream). For example, in the example of FIG. 5, when the node I is the controlling node and the nodes E to H have already been identified as controlled nodes, the node E and the node F are immediately above the node B. In this case, the first node group is a set of the nodes E to I, and the second node group for the node B is a set of the node E and the node F. Here, a node (e.g., the node B) to be processed is excluded from the first node group. The node is not included in the controlled nodes while the processing is being executed. However, the node receives an investment from each of the nodes (e.g., the nodes E and F) included in the second node group. Hence, the node can be interpreted to substantially receive an investment from the controlling node (the node I).

Furthermore, the first threshold is, for example, 0.50 (50%). In this case, the controlled node can be determined from the viewpoint of whether the controlling node has an influence level that allows the controlling node to independently pass an ordinary resolution in the shareholders meeting. Note that the first threshold may also be two-thirds (66.7%); that is, a shareholding ratio capable of independently approving an extraordinary resolution of the shareholders meeting. Alternately, the first threshold may be one-thirds (33.3%); that is, a shareholding ratio capable of independently rejecting an extraordinary resolution of the shareholders meeting. Moreover, the first threshold may be set to a value different from any of these values.

Then, in this embodiment, the controlled node identifying unit 114 uses a sum of the capital contribution ratios (a sum of the shareholding ratios) of the second node group, in order to perform processing to identify the controlled node. Hence, the technique of this embodiment can appropriately determine a control relationship. For example, as described above, the technique can appropriately detect a control relationship in which a plurality of nodes effectively controlled by the controlling node jointly hold a majority of the shares. The specific processing will be described later. Note that the technique of this embodiment may concurrently use an other influence level such as POWER INDEX.

Furthermore, the processing that is performed by the information processing system 10 according to this embodiment may be, in part or in whole, implemented in the form of a program. The processing that is performed by the information processing system 10 is, in a narrow sense, processing that is performed by the processing unit 110 of the server system 100 but may include processing that is performed by the processing unit 210 of the terminal device 200.

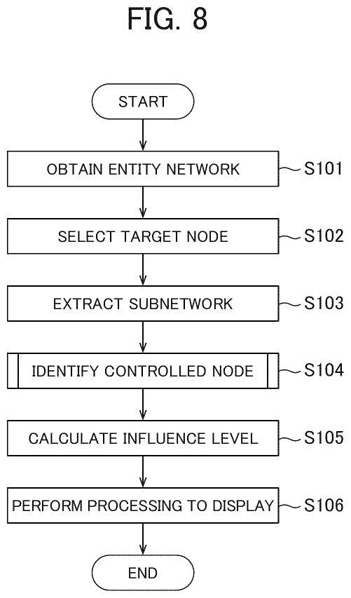

The program according to this embodiment can be stored in a non-transitory information storing medium (an information storing device), an example of which is a computer-readable medium. The information storing medium can be implemented in the form of, but not limited to, an optical disk, a memory card, an HDD, or a semiconductor memory. The semiconductor memory is a ROM, for example. The processing unit 110 and others perform various processes in this embodiment based on programs stored in the information storing medium. That is, the information storing medium stores a program for causing a computer to function as the processing unit 110 and others. The computer is a device provided with an input device, a processing unit, a storage unit, and an output unit. To be specific, the program according to this embodiment is a program for causing a computer to execute individual process steps that will be described later on with reference to, for example, FIGS. 8, 9, and 16.

The technique in this embodiment is also applicable to a method for processing information, which includes steps described below. A method for processing information performed by an information processing device (e.g., the information processing system 10 and the server system 100) includes: obtaining an entity network representing a capital investment relationship between a plurality of nodes each corresponding to one of a plurality of entities, the entity network including a lower node receiving an investment and a higher node making an investment, and the lower node and the higher node being connected together with an edge provided with a capital contribution ratio; and identifying, in accordance with the entity network, a controlled node that is a node to be effectively controlled by a controlling node among the plurality of nodes. When the controlling node and the controlled node that has been identified are set as a first node group, the identifying the controlled node involves performing update processing to identify the controlled node, the update processing adding, to the controlled node, a node included in the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.

### 2.2 Overall Processing

FIG. 8 is a flowchart schematically illustrating processing that is executed on the information processing system 10 according to this embodiment.

First, at Step S101, the entity network obtaining unit 111 obtains the entity network 121. The entity network obtaining unit 111 stores the entity network 121 in the storage unit 120.

At Step S102, the target node obtaining unit 112 obtains, as a target node, any one of the nodes included in the entity network 121. For example, at Step S102, the display processing unit 116 may cause the display unit 240 of the terminal device 200 to display the entity network 121, a screen showing a list of entities included in the entity network 121, or an entity search screen, in order to encourage the user of the terminal device 200 to select the target node. For example, the operation unit 250 of the terminal device 200 may receive an input of a company of interest for which the user desires to conduct a survey on a control level of an other entity, and the target node obtaining unit 112 may obtain, through the communications unit 130, a node corresponding to the company of interest as a target node.

At Step S103, the subnetwork extracting unit 113 extracts a subnetwork including the target node. For example, the subnetwork extracting unit 113 first initializes a network N with the target node. Next, the subnetwork extracting unit 113 adds a node directly making an investment in the target node and an edge representing a capital investment relationship, in order to update the network N. Then, the subnetwork extracting unit 113 adds, to the newly added node, an edge representing a capital investment relationship with a node directly making an investment in the newly added node, in order to update the network N. Thereafter, the subnetwork extracting unit 113 recursively repeats this processing. When the network stops changing, the subnetwork extracting unit 113 stores in the storage unit 120 the stopped subnetwork N as a subnetwork. As described above, the subnetwork here is a network including nodes upstream of the target node and showing a shareholding relationship. Hence, the subnetwork may be referred to as an upstream shareholding network.

At Step S104, if a node among a plurality of nodes included in the subnetwork is a controlling node to possibly control the target node, the controlled node identifying unit 114 performs processing to identify a controlled node to be effectively controlled by the controlling node. This processing, which propagates a control relationship of the controlling node downstream, is also referred to as control propagation processing. Details of the processing to identify the controlled node will be described later.

At Step S105, the influence level calculating unit 115 obtains an influence level representing influence of the controlling node on an other node, in accordance with a result of identifying the controlled node. Details of the processing to calculate the influence level will be described later.

At Step S106, the display processing unit 116 performs processing to cause the display unit 240 of the terminal device 200 to display the result of identifying the controlled node. Furthermore, the display processing unit 116 may perform processing to cause the display unit 240 of the terminal device 200 to display a result of calculating the influence level. For example, the display processing unit 116 may cause the display unit 240 to display a result of determining whether the target node selected by the user is effectively controlled by an other node, and to display an influence level of the controlling node on the target node.

### 2.3 Controlled Node Identification Processing (Control Propagation Processing)

FIG. 9 is a flowchart showing processing to identify a controlled node at Step S104 in FIG. 8.

At Step S201, the controlled node identifying unit 114 selects the controlling node from the plurality of nodes included in the subnetwork. For example, the controlled node identifying unit 114 selects, as the controlling node, a node that is included in the subnetwork and other than the target node. Here, the node has the capital contribution ratio to at least an other node, and the capital contribution ratio is higher than the first threshold. Specifically, the controlled node identifying unit 114 determines whether each of the nodes that is included in the subnetwork and other than the target node is provided with an edge that has: a direction from the node to an other node; and a capital contribution ratio assigned thereto and exceeding the first threshold value. The controlled node identifying unit 114 selects a node satisfying a condition as a candidate node of the controlling node. Then, the controlled node identifying unit 114 sequentially selects any one or more of candidate nodes as controlling nodes. Note that, here, the first threshold is, for example, 0.50 (50%) as described above. Alternatively, the first threshold may be an other value.

In the case of the network in FIG. 5, a shareholding ratio of the node I in relation to each of the nodes E to H, which are nodes other than the node I itself, exceeds 0.50; that is, the first threshold. Hence, the node I is selected as a candidate for the controlling node. The node E has a shareholding ratio of 0.30 in relation to the node B and to the node C, which does not exceed the first threshold. Hence, the node E is not a candidate for the controlling node. The same applies to the other nodes. In FIG. 5, only the node I is the candidate for the controlling node. Thus, the controlled node identifying unit 114 executes the processing below for the node I, in order to execute processing to identify a controlled node to be effectively controlled by the node I.

At Step S202, the controlled node identifying unit 114 initializes, with an empty set, a set P of controlled nodes to be effectively controlled by the controlling node.

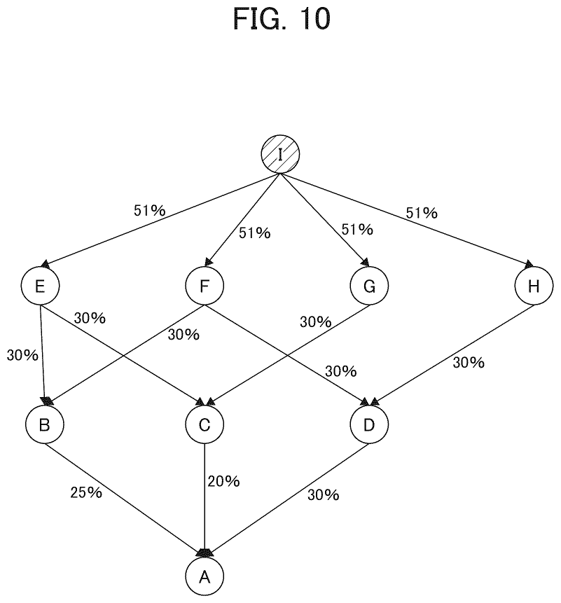

In the processing below, the first node group is a set of the controlling node itself and controlled nodes effectively controlled by the controlling node. The first node group is a sum set of the controlling node and the set P. FIG. 10 illustrates the first node group after the processing at Step S202. As illustrated in FIG. 10, no controlled node is identified at Step S202, and only the node I; namely, the controlling node, is included in the first node group.

At Step S203, the controlled node identifying unit 114 performs first update processing to update the controlled node set P. Specifically, the controlled node identifying unit 114 performs update processing to add, to the controlled node set P, a node controlled by the controlling node that has a shareholding ratio exceeding the first threshold.

In the case of the network in FIG. 5, a shareholding ratio of the node I in relation to each of the nodes E to H, which are nodes other than the node I itself, exceeds 0.50; that is, the first threshold. Hence, at Step S203, the controlled node identifying unit 114 executes processing to add the nodes E to H to the set P.

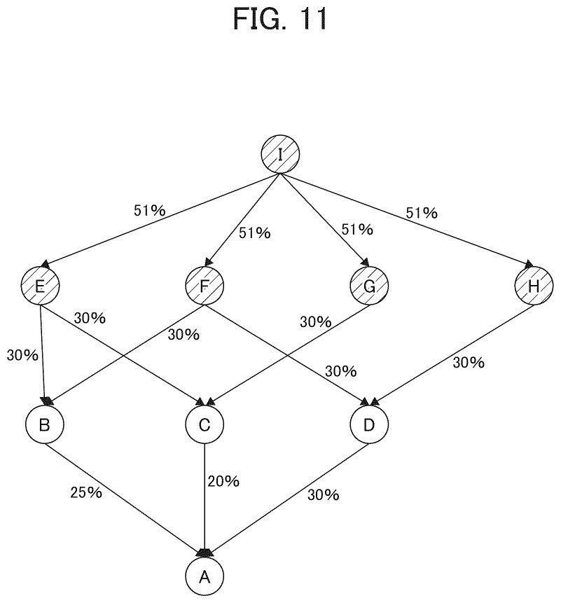

FIG. 11 illustrates the first node group after the processing at Step S203. As illustrated in FIG. 11, the first update processing at Step S203 adds, to the controlled node set P, the nodes E to H directly controlled by the node I with a shareholding ratio exceeding the first threshold. Here, the node I is the controlling node. Hence, the first node group is a set of five nodes: the nodes E to I. That is, the first update processing propagates a control relationship from the controlling node to the nodes one stage downstream.

At Step S204, the controlled node identifying unit 114 performs second update processing to update the controlled node set P. Specifically, the controlled node identifying unit 114 performs update processing to add, to the controlled node set P, a node controlled either by a node included in the first node group and having a shareholding ratio exceeding the first threshold by itself, or by nodes included in the first node group and having shareholding ratios exceeding the first threshold collectively.

More specifically, the controlled node identifying unit 114 identifies a node included in the subnetwork and directly connected to the second node group of the first node group. In other words, the node identified here is a node one stage downstream of one or more nodes included in the first node group. Then, for each identified node, the controlled node identifying unit 114 obtains a sum of shareholding ratios of the second node group. If the sum exceeds the first threshold, the controlled node identifying unit 114 performs processing to add the node to be processed to the controlled node set P.

For example, the first node group, which is immediately before the initial second update processing, includes five nodes E to I as described above with reference to FIG. 11. In this case, the nodes B to D are directly connected to nodes included in the first node group. In other words, each of the nodes B to D is a node immediately below the nodes included in the first node group (i.e., a node one stage downstream). Hence, the controlled node identifying unit 114 obtains a sum of shareholding ratios for each of the nodes B to D.

Specifically, the node B is directly connected to the node E and the node F among the nodes included in the first node group (i.e., the node B is immediately below the node E and the node F). Hence, the second node group for the node B is a set of the node E and the node F. The controlled node identifying unit 114 obtains a sum of a shareholding ratio of the node E in relation to the node B and a shareholding ratio of the node F in relation to the node B. In this case, each of the shareholding ratios is 30%, and the sum of the shareholding ratios is 60%. Because the sum of the shareholding ratios exceeds 50%; namely, the first threshold, the controlled node identifying unit 114 performs processing to add the node B to the controlled node set P.

Likewise, the second node group for the node C is a set of the node E and the node G. A sum of the shareholding ratios of the node E and the node G is 60%, which exceeds the first threshold. The controlled node identifying unit 114 adds the node C to the controlled node set P. Furthermore, the second node group for the node D is a set of the node F and the node H. A sum of the shareholding ratios of the node F and the node His 60%, which exceeds the first threshold. The controlled node identifying unit 114 adds the node D to the controlled node set P.

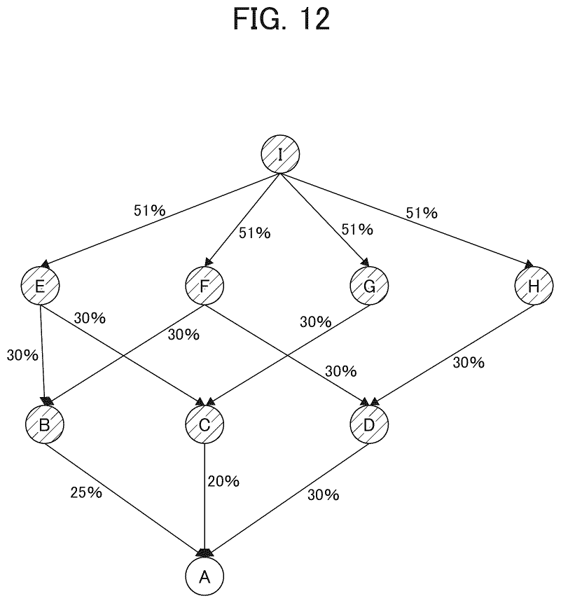

FIG. 12 illustrates the first node group after the second update processing has been performed for the first time. As illustrated in FIG. 12, the second update processing for the first time adds the nodes B to D to the controlled node set P. The nodes B to D are jointly controlled by the controlled nodes E to H with a shareholding ratio exceeding the first threshold. Hence, the first node group is a set of eight nodes: the nodes B to I. That is, the second update processing propagates a control relationship of the controlling node from a preprocess state to the nodes one stage downstream. Note that exemplified here is a case where the second node group for each node includes a plurality of nodes. However, the second node group may include a single node.

After the second update processing is executed, at Step S205, the controlled node identifying unit 114 determines whether the controlled node set P has been changed by the second update processing. In the above example, the nodes B to D are added to the controlled node set P. Hence, the set P has been changed.

If the controlled node set P has been changed by the second update processing (Step S205: YES), the controlled node identifying unit 114 returns to Step S204 and recursively executes the second update processing. For example, after the second update processing has been performed for the first time, the first node group includes the nodes B to I as illustrated in FIG. 12. In this case, the node A is directly connected to the nodes included in the first node group (i.e., the node A is directly below the nodes included in the first node group). Hence, in the second update processing for the second time, the controlled node identifying unit 114 obtains a sum of shareholding ratios for the node A.

Specifically, the node A is connected to the nodes B to D among the nodes included in the first node group. Hence, the second node group for the node A is a set of the nodes B to D. The controlled node identifying unit 114 obtains a sum of shareholding ratios of the nodes B, C, and D in relation to the node A. In this case, the sum of the shareholding ratios is 0.25+0.20+0.30=0.75 (75%). Because the sum of the shareholding ratios exceeds 50%; namely, the first threshold, the controlled node identifying unit 114 performs processing to add the node A to the controlled node set P.

FIG. 13 illustrates the first node group after the second update processing has been performed for the second time. As illustrated in FIG. 13, the second update processing for the second time adds the node A to the controlled node set P. The node A is jointly controlled by the controlled nodes B to D with a shareholding ratio exceeding the first threshold. Hence, the first node group is a set of nine nodes: the nodes A to I. That is, the second update processing propagates a control relationship of the controlling node from a preprocess state to the nodes one stage downstream.

As can be seen, in this embodiment, the controlled node identifying unit 114 may: perform initialization processing to initialize the controlled node with an empty set (Step S202); perform, after the initialization processing, the first update processing to add a node to the controlled node, the node being included in the plurality of nodes, being directly connected to the controlling node, and having the capital contribution ratio assigned to the edge between the node and the controlling node, and the capital contribution ratio being greater than the first threshold (Step S203); and repeatedly execute the second update processing after the first update processing (Step S204) to identify the controlled node. Thanks to such a feature, a control relationship is propagated downstream with the controlling node serving as a starting point. Such top-down processing makes it possible to efficiently obtain a control path and a control range of the controlling node.

After the second update processing is executed, at Step S205, the controlled node identifying unit 114 determines whether the controlled node set P has been changed by the second update processing. In the above example, the node A is added to the controlled node set P. Hence, the set P has been changed. Thus, the controlled node identifying unit 114 returns to Step S204 and executes the second update processing for the third time.

As illustrated in FIG. 13, in the network exemplified here, all the nodes of the subnetwork have been added to the first node group in the second update processing for the second time. Hence, even if the second update processing is performed for the third time, the controlled node set P does not change.

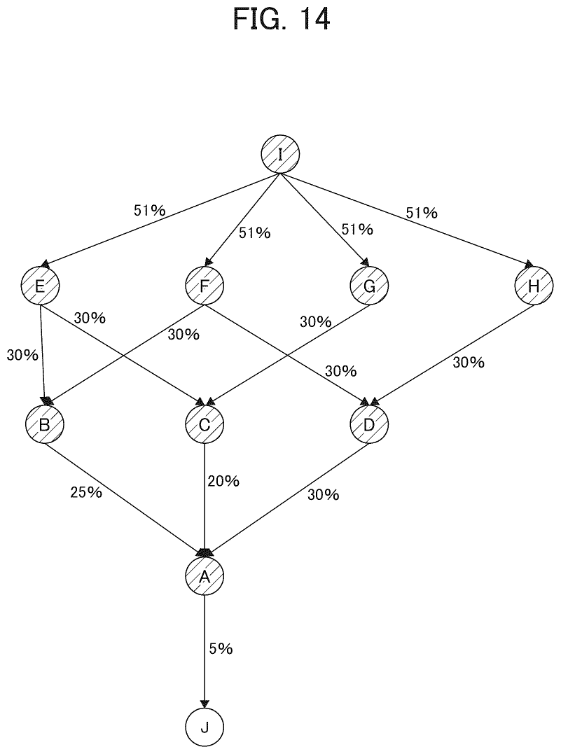

In addition, the controlled node set P does not change in a network illustrated in FIG. 14. The network illustrated in FIG. 14 is the same as the network described with reference to FIGS. to 13, as to the node A to the node I. In the network, a node J is added as a node immediately below the node A. A shareholding ratio of the node A in relation to the node J is 5%.

In this case, as can be seen in the example described above, the nodes A to I are included in the first node group by the second update processing for the second time. Because the node J is directly connected to the node A included in the first node group, a sum of shareholding ratios is obtained. For the node J, the second node group includes the node A alone. Hence, the sum of shareholding ratios is 5%. The sum of the shareholding ratios does not exceed the first threshold. Hence, the controlled node identifying unit 114 does not add the node J to the controlled node set P. As can be seen, even if there is a remaining node not added to the controlled node set P, the controlled node set P does not change unless a sum of shareholding ratios in the second node group exceeds the first threshold for any node.

If the controlled node set P does not change even if the second update processing is performed (Step S205: NO), the controlled node identifying unit 114 finishes the second update processing. Such a feature makes it possible to appropriately end the second update processing executed recursively. The controlled node identifying unit 114 identifies the nodes included in the set P at this moment as controlled nodes effectively controlled by the controlling node.

Then, at Step S206, the controlled node identifying unit 114 determines whether the processing has been completed for all the candidate nodes for the controlling node. For example, if a plurality of candidate nodes are found at Step S201, and there remains a candidate node not subjected to the processing at Steps S202 to S205 (Step S206: NO), the controlled node identifying unit 114 returns to Step S201 and selects the unprocessed candidate node as a new controlling node. After the controlling node is newly selected, the processing to be carried out at Steps S202 to S205 is the same as the processing exemplified above.

When the processing at Steps S202 to S205 ends for all the candidate nodes (Step S206: YES), the controlled node identifying unit 114 ends the processing to identify a controlled node, which is illustrated in FIG. 9.

### 2.4 Influence Level Calculation Processing

Described next will be the processing to calculate an influence level shown at Step S105 in FIG. 8. The influence level calculating unit 115 of this embodiment calculates, as an influence level, an index value based on a state of how the controlling node effectively controls an other node.

For example, the influence level calculating unit 115 sets a maximum value for an influence level of the controlling node on the controlled node. Such a feature makes it possible to set an appropriate value as the influence level for a node effectively controlled by the controlling node. In the example of FIG. 14, the node I effectively controls the nodes A to H. Hence, the influence level calculating unit 115 sets the maximum value (e.g., 1) for the influence level of the node I on each of the nodes A to H.

Furthermore, if a target node among the plurality of nodes is not included in the first node group after the processing to identify the controlled node ends, the influence level calculating unit 115 may obtain an influence level of the controlling node on the target node in accordance with the capital contribution ratio assigned to the edge directly connecting together the target node and a node included in the first node group. When stocks of the target node are obtained by a group (i.e., the first node group) including the controlling node and a group of nodes effectively controlled by the controlling node, the above feature makes it possible to set an influence level, for the target node, based on a shareholding ratio of the target node. In the example of FIG. 14, the node J is connected to the node A included in the first node group, and the shareholding ratio of the node A in relation to the node J is 5%. Hence, the influence level calculating unit 115 sets 0.05 (5%) corresponding to the shareholding ratio as an influence level of the node I on the node J. Thanks to such a feature, the influence level is represented by a value based on voting rights (a shareholding ratio) to be substantially exercised by the controlling node. Thus, the feature makes it possible to set an easy-to-understand index value.

For example, the Japanese Companies Act allows a shareholder who has a shareholding ratio exceeding 1% to have a right to request a bill of a general shareholders meeting in a company with the board of directors. Furthermore, a shareholder who has a shareholding ratio exceeding 3% is allowed to have a right to request to call a general shareholders meeting, and a right to request to inspect and copy accounting records. In using the influence level of this embodiment, easy determination can be made to find out whether the controlling node can exercise these rights to a target node.

Moreover, the influence level calculating unit 115 identifies one or a plurality of edges directly connecting together the target node and any one or more nodes included in the first node group, and obtains a sum of the capital contribution ratios assigned to the identified one or plurality of edges as an influence level of the controlling node on the target node.

For example, in FIG. 14, the node J is connected only to the node A. In relation to the network in FIG. 14, considered here is a network additionally including an edge directed from the node B to the node J and associated with a capital contribution ratio of 10%. In this case, edges directly connected to the node J as the target node are two edges: an edge from the node A to the node J, and an edge from the node B to the node J. The influence level calculating unit 115 sets 0.05+0.10=0.15 (15%); that is, a sum of shareholding ratios each assigned to a corresponding edge, as an influence level of the node I on the node J. Through the node A, the node I can exercise voting rights equivalent to 5% of all the stocks (in a narrow sense, stocks with voting rights) of the node J. Simultaneously, through the node B, the node I can exercise voting rights equivalent to 10% of all the stocks of the node J. That is, if a plurality of nodes included in the first node group is a node immediately above the target node, the influence level calculating unit 115 uses the sum of the shareholding ratios of the edges, thereby successfully setting, as an influence level, a value corresponding voting rights (a shareholding ratio) to be substantially exercised by the controlling node.

Furthermore, if the target node is not directedly connected to any of the nodes included in the first node group, the influence level calculating unit 115 sets a minimum value for an influence level of the controlling node on the target node. For example, in relation to the network illustrated in FIG. 14, considered is a network additionally including a node K immediately below the node J. In this case, the node K is connected only to the node A through the node J not included in the first node group. The node K is not directedly connected to any of the nodes included in the first node group. Here, the influence level calculating unit 115 sets a minimum value (e.g., 0) for an influence level of the node I on the node K. As described above, through the node A, the node I can sorely exercise voting rights equivalent to 5% of the node J. The node I cannot control an action of the node J in a resolution of the node K. That is, the node I cannot exert definite influence in the resolution of the node K. Such a feature sets a minimum value for the influence level, thereby making it possible to set a realistic value.

### 2.5 Output Processing

At Step S106 in FIG. 8, the display processing unit 116 may perform, in the entity network, processing to display a controlling node and a controlled node in a manner distinguishable from an other node. For example, as illustrated in FIG. 13 or FIG. 14, the display processing unit 116 causes the display unit 240 of the terminal device 200 to: display, in a first mode, the first node group observed when the processing to identify a controlled node (Step S104) ends; and display, in a second mode different from the first mode, a node other than the first node group. Such a feature makes it possible to present the user through which path the controlling node effectively controls an other node, using an easy-to-understand mode. Note that the first mode and the second mode are different in color of nodes to be displayed. However, the first node and the second may be displayed in any given manner. The first mode may be higher in visibility than the second mode. For example, the first mode may display nodes larger in size than the second node. Alternatively, the display processing unit 116 may display only the nodes in the first mode on a default screen, and may perform processing to display the nodes in the second mode when receiving a user operation of some kind. Otherwise, various modifications can be made to the specific display modes. Furthermore, the display processing unit 116 may display an edge, whose opposing nodes are included in the first node group, in a higher visibility mode than an other edge (i.e., an edge whose node at least one end is a node other than the first node group).

Moreover, the display processing unit 116 may perform processing to display a value of an influence level of the controlling node on a node other than the first node group.

In addition, the display processing unit 116 may selectively display a screen to display an influence level according to this embodiment and a screen to display an other influence level such as POWER INDEX. Otherwise, various modifications can be made to a specific screen to be displayed by the display processing unit 116.

### 2.6 Matrix Operation

The above-described processing to identify a controlled node and processing to calculate an influence level may be performed by an operation using a matrix and a vector. A specific example of the operation will be described below.

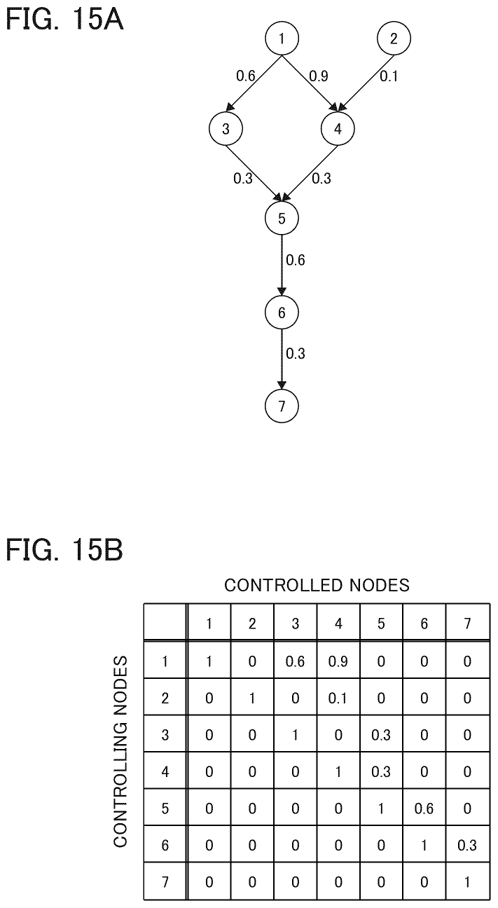

FIG. 15A illustrates an example of a network of the specific example. Here, the network is a subnetwork to be extracted at, for example, Step S103 in FIG. 8. Examined here is a network including nodes 1 to 7 corresponding to entities 1 to 7. A connection relationship of each of the nodes and shareholding ratios assigned to the edges are given in the drawing.

The controlled node identifying unit 114 sets an incidence matrix representing a connection relationship between a plurality of nodes included in the network. For example, when first to N-th nodes are included in a subnetwork directly or indirectly connected to the controlling node in the entity network (N is an integer of 2 or more), the controlled node identifying unit 114 obtains an incidence matrix of N rows and N columns in which a value of an entry in row i (i is an integer of 1 or more and N or less) and column i is 1, and a value of an entry in row i and column j (j is an integer of 1 or more and N or less and different from i) is a value indicating the capital contribution ratio of an i-th node to a j-th node.

FIG. 15B is a table showing an example of an incidence matrix for the subnetwork in FIG. 15A. As shown in FIG. 15B, row entries of the incidence matrix represent controlling nodes, and column entries of the incidence matrix represent controlled nodes. First, the controlled node identifying unit 114 sets 1 for values of diagonal entries in the incidence matrix.

Furthermore, the controlled node identifying unit 114 determines values of the other entries in accordance with a connection relationship between the nodes and shareholding ratios assigned to the edges. For example, in the subnetwork in FIG. 15A, a shareholding ratio of the node 1 in relation to the node 3 is 0.6. Hence, in the incidence matrix, a value of an entry in low 1 and column 3 is set to 0.6. Likewise, a shareholding ratio of the node 1 in relation to the node 4 is 0.9. Hence, in the incidence matrix, a value of an entry in low 1 and column 4 is set to 0.9. The same applies to the subsequent entries. In accordance with the connection relationship of the subnetwork shown in FIG. 15A, values representing shareholding ratios are set to the entries in low 2 and column 4, row 3 and column 5, row 4 and column 5, row 5 and column 6, and row 6 and column 7 in the incidence matrix. As to the other elements, the i-th node does not have a relationship to make an investment in the j-th node. Hence, the value is set to 0.

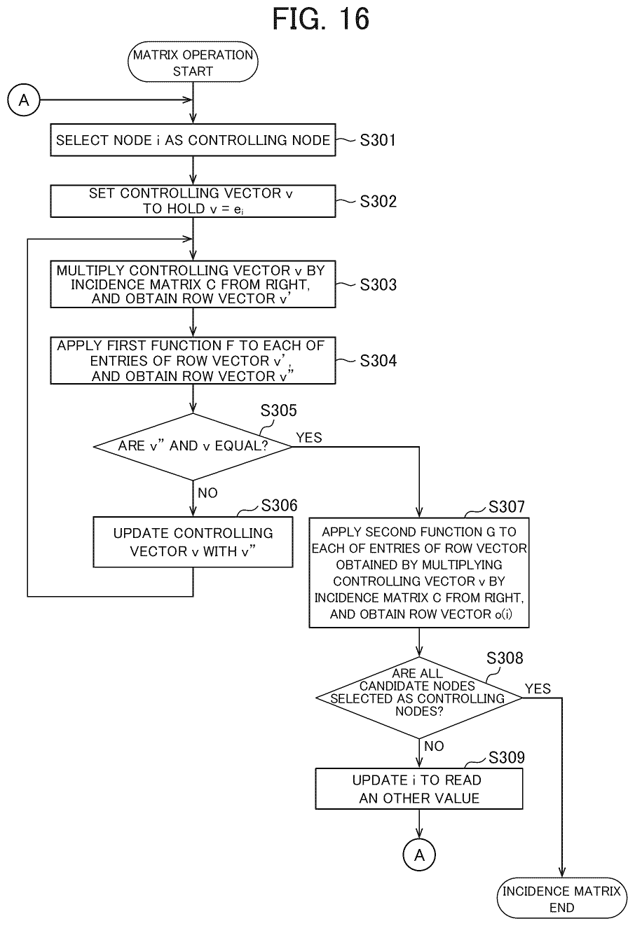

FIG. 16 is a flowchart showing processing to identify a controlled node by a matrix operation and calculate an influence level. It is assumed that the incidence matrix has already been obtained before the processing.

At Step S301, the controlled node identifying unit 114 selects the node i as a controlling node. The processing at Step S301 is the same as the processing at S201 in FIG. 9. That is, the controlled node identifying unit 114 selects, as a candidate node of the controlling node, a node that is included in the subnetwork and other than the target node. The node controls an other node than the node itself with a shareholding ratio exceeding the first threshold. Then, the controlled node identifying unit 114 sequentially selects any one or more of candidate nodes as controlling nodes. In the example of FIG. 15A, the node 1 and the node 5 are candidate nodes for the controlling nodes. Hence, the controlled node identifying unit 114 sequentially selects 1 and 5 as i. Here, first, i=1 is set, for example.

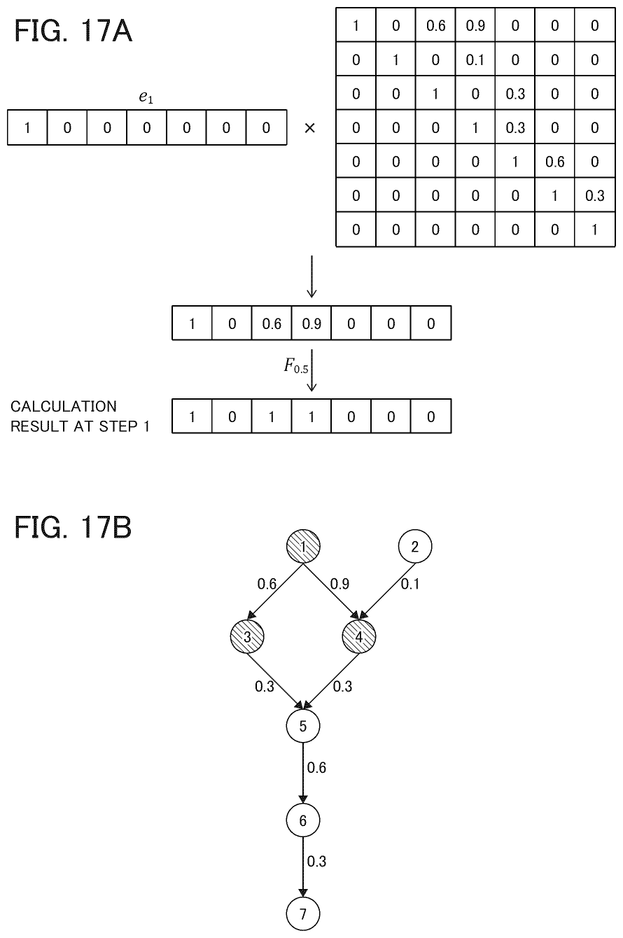

At Step S302, the controlled node identifying unit 114 initializes a controlling vector v with a vector eᵢ. The controlling vector v is a vector representing a control relationship of a controlling node (i.e., the node i). Here, the vector eᵢ is an N-dimensional row vector. For the vector eᵢ, only a value of an i-th entry is 1, and values of the other entries are set to 0. In a case of i=0, as illustrated in FIG. 17, the controlling vector v is a row vector set to eₗ. For eₗ, a first entry is 1 and other entries are set to 0. The controlled node identifying unit 114 performs processing to obtain the controlled node, using a product of the controlling vector and the incidence matrix. Such a feature makes it possible to achieve the processing to obtain a controlled node by an operation using a matrix and a vector.

For example, for each of the entries of an N-dimensional vector that is a product of the controlling vector and the incidence matrix, the controlled node identifying unit 114 performs vector update processing to: perform processing to update a value of an entry greater than the first threshold to read a first value, and to update a value of an entry smaller than, or equal to, the first threshold to read a second value smaller than the first value; and update the controlling vector with the N-dimensional vector that has been processed. Such a feature makes it possible to achieve the control propagation processing, described above with reference to FIGS. 10 to 13, in the form of updating a controlling vector.

Specifically, at Step S303, the controlled node identifying unit 114 multiplies the controlling vector v by an incidence matrix C from the right, and obtains a row vector v′ as a result of the multiplication. As shown in FIG. 17A, in the vector update processing for the first time, the controlling vector is eₗ. Hence, the result of the multiplication v′ holds v′=(1, 0, 0.6, 0.9, 0, 0, 0).

At Step S304, the controlled node identifying unit 114 applies a first function F to each of the entries of the vector v′ to obtain a row vector v″ as a result of the application. Here, the first function F is a function to satisfy an equation (1) below. In the equation (1) below, θ is a value corresponding to the first threshold described above. That is, the first function F is a function to: update a value of an entry greater than the first threshold to read the first value (e.g., 1); and update a value of an entry smaller than, or equal to, the first threshold to read the second value (e.g., 0).

$${F}_{θ} ( x ) = \{ \begin{matrix}1 ( x > θ ) \\ 0 ( x \leq θ )\end{matrix} \qquad [ Math . 1 ]$$

As shown in FIG. 17A, the first function F (F_{0.5}) wherein θ=0.5 is applied to the vector v′, so that v″=(1, 0, 1, 1, 0, 0, 0) is obtained.

At Step S305, the controlled node identifying unit 114 determines whether the controlling vector v and the vector v″ are equal. This processing corresponds to Step S205 in FIG. 9; that is, the determination whether the control propagation continues. If the controlling vector v and the vector v″ are not equal (Step S305: NO), at Step S306, the controlled node identifying unit 114 updates the controlling vector v with the vector v″. After that, the controlled node identifying unit 114 returns to Step S303 to execute the vector update processing again. Hereinafter, the vector update processing for an x-th time is referred to as an x-th step.

As described above, as a result of a first step, the controlling vector v is updated to hold v=(1, 0, 1, 1, 0, 0, 0). As illustrated in FIG. 17B, this result shows a state in which the control by the node 1 is propagated to the nodes 3 and 4 corresponding to the third and fourth entries of the controlling vector v.

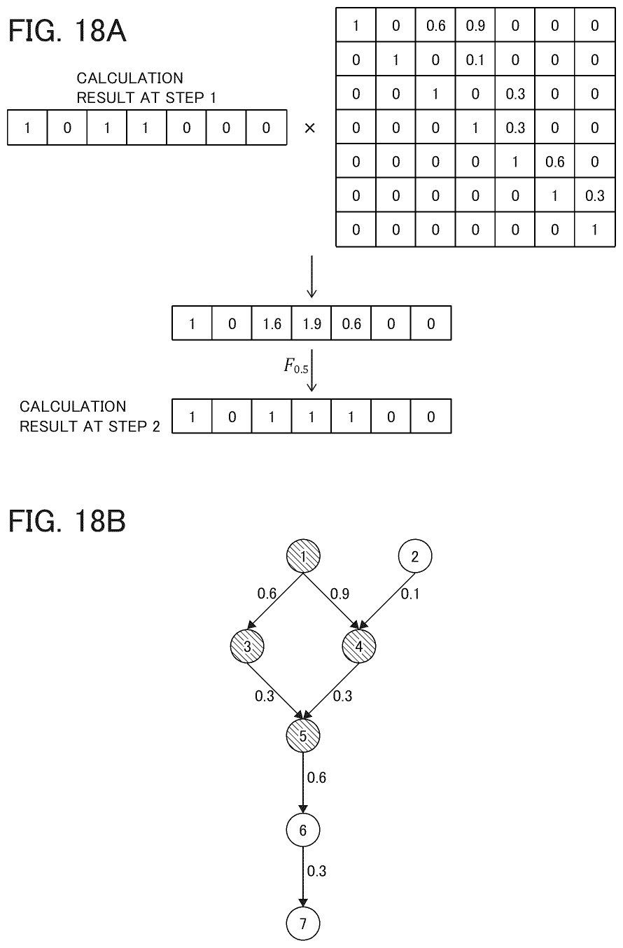

At a second step, as illustrated in FIG. 18A, the controlling vector v=(1, 0, 1, 1, 0, 0, 0) after the update at the first step is multiplied by the incidence matrix (Step S303). A result of the multiplication v′ holds v′=(1, 0, 1.6, 1.9, 0.6, 0, 0). Furthermore, the first function F is applied to the vector v′, so that v″=(1, 0, 1, 1, 0, 0, 0) is obtained (Step S304). Also in this case, the controlling vector v and the vector v″ are not equal (Step S305: NO). At Step S306, the controlled node identifying unit 114 updates the controlling vector v with the vector v″. After that, the controlled node identifying unit 114 returns to Step S303 to execute the vector update processing again.

As result of the second step, the controlling vector v is updated to hold v=(1, 0, 1, 1, 1, 0, 0). As illustrated in FIG. 18B, this result shows a state in which the control by the node 1 is propagated to the node 5 corresponding to the fifth entry of the controlling vector v.

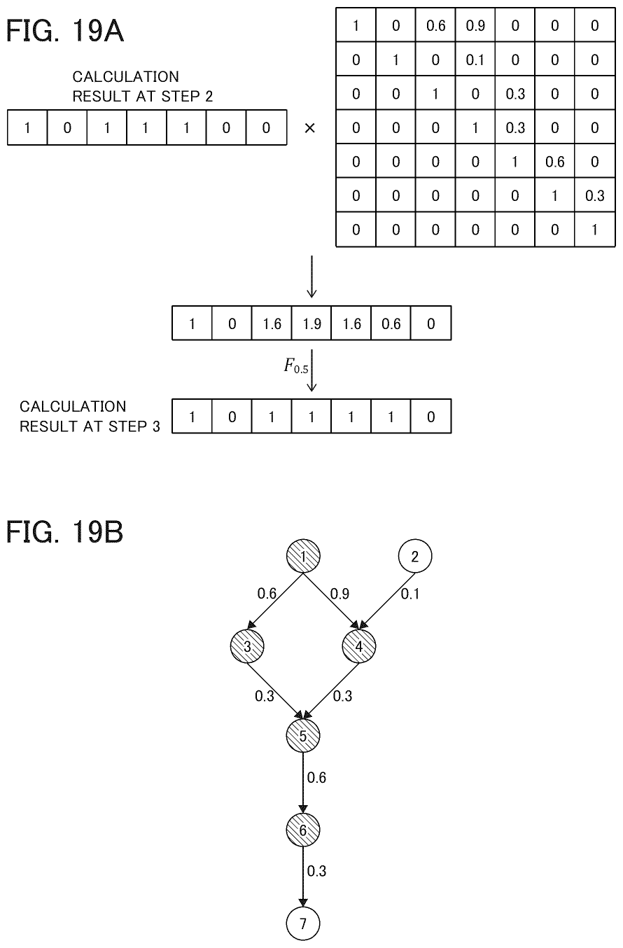

At a third step, as illustrated in FIG. 19A, v=(1, 0, 1, 1, 1, 0, 0) is multiplied by the incidence matrix (Step S303). A result of the multiplication v′ holds v′=(1, 0, 1.6, 1.9, 1.6, 0.6, 0). Furthermore, the first function F is applied to the vector v′, so that v″=(1, 0, 1, 1, 1, 1, 0) is obtained (Step S304). Also in this case, the controlling vector v and the vector v″ are not equal (Step S305: NO). At Step S306, the controlled node identifying unit 114 updates the controlling vector v with the vector v″. After that, the controlled node identifying unit 114 returns to Step S303 to execute the vector update processing again.

As result of the third step, the controlling vector v is updated to hold v=(1, 0, 1, 1, 1, 1, 0). As illustrated in FIG. 19B, this result shows a state in which the control by the node 1 is propagated to the node 6 corresponding to the sixth entry of the controlling vector v.

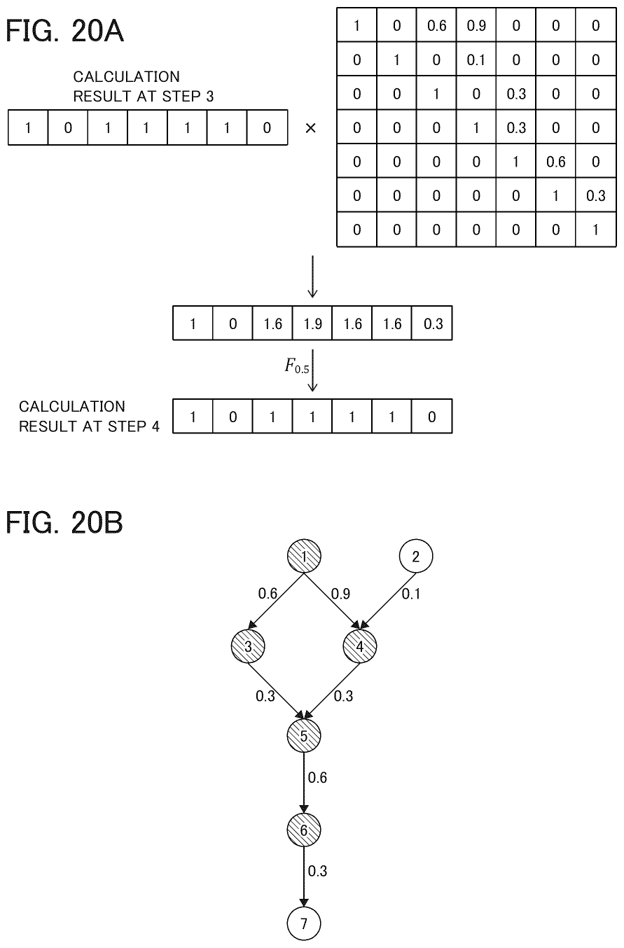

At a fourth step, as illustrated in FIG. 20A, v=(1, 0, 1, 1, 1, 1, 0) is multiplied by the incidence matrix (Step S303). A result of the multiplication v′ holds v′=(1, 0, 1.6, 1.9, 1.6, 1.6, 0.3). Furthermore, the first function F is applied to the vector v′, so that v″=(1, 0, 1, 1, 1, 1, 0) is obtained (Step S304). In this case, the controlling vector v and the vector v″ are equal (Step S305: YES). The controlled node identifying unit 114 finishes the vector update processing.

As result of a fourth step, the update processing ends when the controlling vector v holds v=(1, 0, 1, 1, 1, 1, 0). As illustrated in FIG. 20B, this result shows a state in which the control by the node 1 is propagated to, but not further than, the node 6 corresponding to the sixth entry of the controlling vector v.

For the controlling vector after the vector update processing ends, the controlled node identifying unit 114 identifies, as the controlled node, a node corresponding to an entry a value of which is a first value (e.g., 1). Thanks to such a feature, a controlled node to be effectively controlled by a controlling node can be obtained more efficiently, using a matrix operation

Furthermore, for each of the entries of an N-dimensional vector that is the product of the controlling vector and the incidence matrix after the vector update processing ends, the influence level calculating unit 115: performs processing to update a value of an entry greater than the first threshold to read 1, and to maintain a value of an entry smaller than, or equal to, the first threshold; and obtains a value of each of the entries of the N-dimensional vector, which has been processed, as an influence level of the controlling node on each of the plurality of nodes. Thanks to such a feature, an influence level reflecting an effective control relationship can be obtained by a matrix operation.

Specifically, after the vector update processing, at Step S307, the influence level calculating unit 115 multiplies the controlling vector v by the incidence matrix to obtain a row vector, and applies a second function G to each of entries of the row vector. Here, the second function G is a function to satisfy an equation (2) below. In the equation (2) below, 0 is a value corresponding to the first threshold described above. That is, the second function G is a function to: update a value of an entry greater than the first threshold to read the first value (e.g., 1); and maintain, as it is, a value of an entry smaller than, or equal to, the first threshold.

$${G}_{θ} ( x ) = \{ \begin{matrix}1 ( x > θ ) \\ x ( x \leq θ )\end{matrix} \qquad [ Math . 2 ]$$

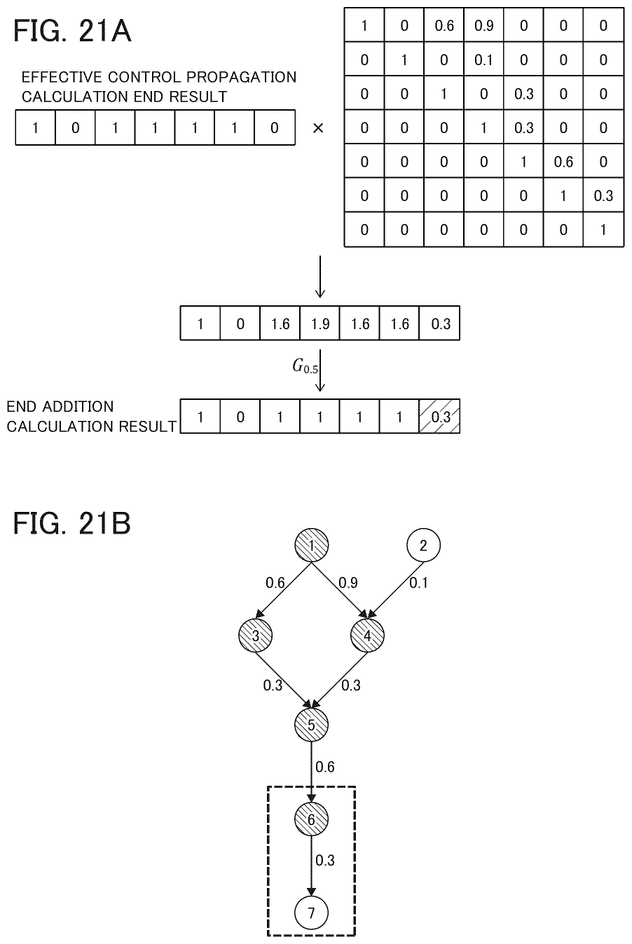

As illustrated in FIG. 21A, the controlling vector v=(1, 0, 1, 1, 1, 1, 0) at the end of the vector update processing is multiplied by the incidence matrix. A result of the multiplication, a row vector, holds (1, 0, 1.6, 1.9, 1.6, 1.6, 0.3). Furthermore, the second function G is applied to the row vector. As a result, o(i) is obtained to hold o(i)=(1, 0, 1, 1, 1, 1, 0.3).

Here, each of the entries of the vector o(i) represents an influence level of the node i, which is the controlling node, on other nodes. For example, values of the third to sixth entries of o(i) are 1, which shows that an influence level of the node 1 on the nodes 3 to 6 is 1 (a maximum value), and the nodes 3 to 6 are controlled nodes. Moreover, a value of a seventh entry of o(i) is 0.3. Hence, an influence level of the node 1 on a node 7 is 0.3. This reflects a connection relationship in the region surrounded by a broken line in FIG. 21B. That is, a node immediately above the node 7 is the node 6; that is, a controlled node. Hence, by the node 1 through the node 6, the node 7 might possibly be exercised voting rights equivalent to 30%. As an advantageous effect of the second function G, the technique of this embodiment can obtain an influence level whose value reflects a control relationship.

At Step S308, the controlled node identifying unit 114 determines whether all the candidate nodes are selected as controlling nodes. As described above, the candidate nodes here are two nodes; that is, the node 1 and the node 5. The node 5 is not processed. If an unprocessed candidate node remains (Step S308: NO), at Step S309, the controlled node identifying unit 114 updates the value of i to read a value of the unprocessed candidate node. In this case, the value of i is updated to read 5. After that, the controlled node identifying unit 114 returns to Step S301 and executes the above processing for a new controlling node.

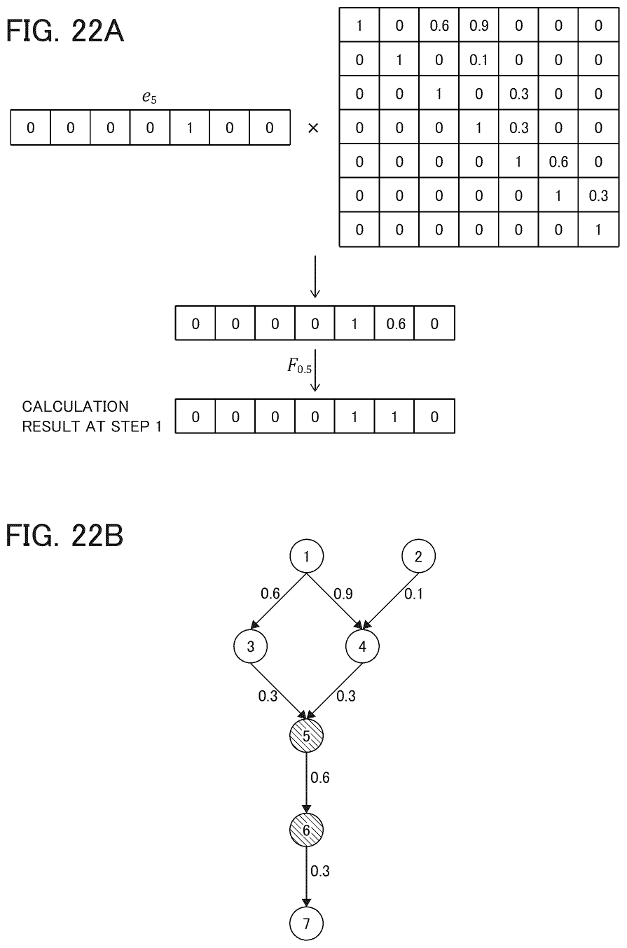

FIGS. 22A to 24B show a sequence of processing performed when the node 5 is the controlling node. Here, initial values of the controlling vector v represent a vector e₅ in which a value of the fifth entry is 1 and values of the other entries are set to 0. The incidence matrix is the same as the incidence matrix described above as an example.

At the first step, as illustrated in FIG. 22A, e₅=(0, 0, 0, 0, 1, 0, 0) is multiplied by the incidence matrix (Step S303). A result of the multiplication v′ holds v′=(0, 0, 0, 0, 1, 0.6, 0). Furthermore, the first function F is applied to the vector v′, so that v″=(0, 0, 0, 0, 1, 1, 0) is obtained (Step S304). The controlling vector v(e₅) and the vector v″ are not equal (Step S305: NO). At Step S306, the controlled node identifying unit 114 updates the controlling vector v with the vector v″. After that, the controlled node identifying unit 114 returns to Step S303 to execute the vector update processing again.

As result of the second step, the controlling vector v is updated to hold v=(0, 0, 0, 0, 1, 1, 0). As illustrated in FIG. 22B, this result shows a state in which the control by the node 5 is propagated to the node 6 corresponding to the sixth entry of the controlling vector v.

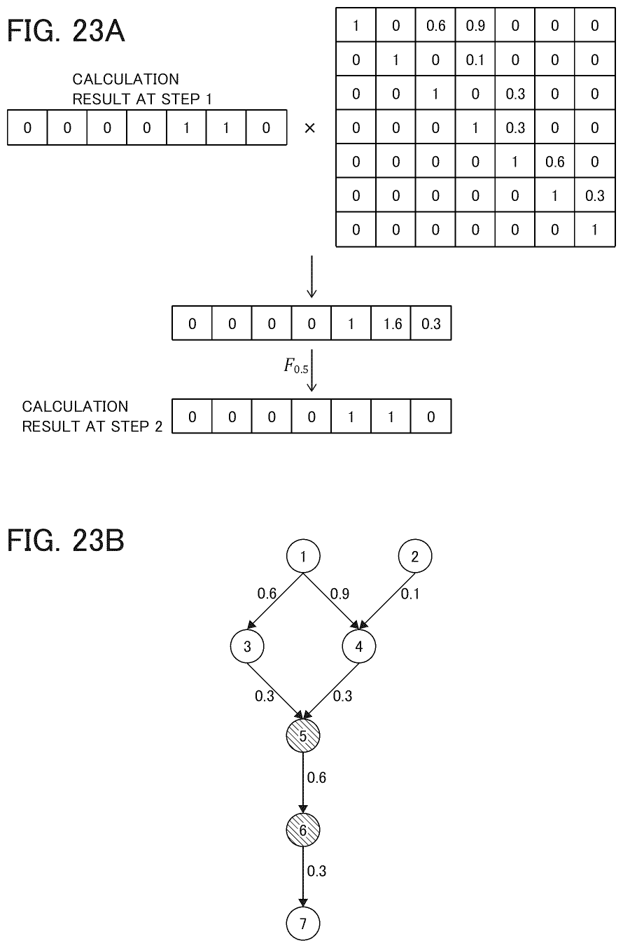

At the second step, as illustrated in FIG. 23A, v=(0, 0, 0, 0, 1, 1, 0) is multiplied by the incidence matrix (Step S303). A result of the multiplication v′ holds v′=(0, 0, 0, 0, 1, 1.6, 0.3). Furthermore, the first function F is applied to the vector v′, so that v″=(0, 0, 0, 0, 1, 1, 0) is obtained (Step S304). The controlling vector v and the vector v″ are equal (Step S305: YES). The controlled node identifying unit 114 finishes the vector update processing.

As a result of the second step, the update processing ends when the controlling vector v holds v=(0, 0, 0, 0, 1, 1, 0). As illustrated in FIG. 23B, this result shows a state in which the control by the node 5 is propagated to, but not further than, the node 6 corresponding to the sixth entry of the controlling vector v.

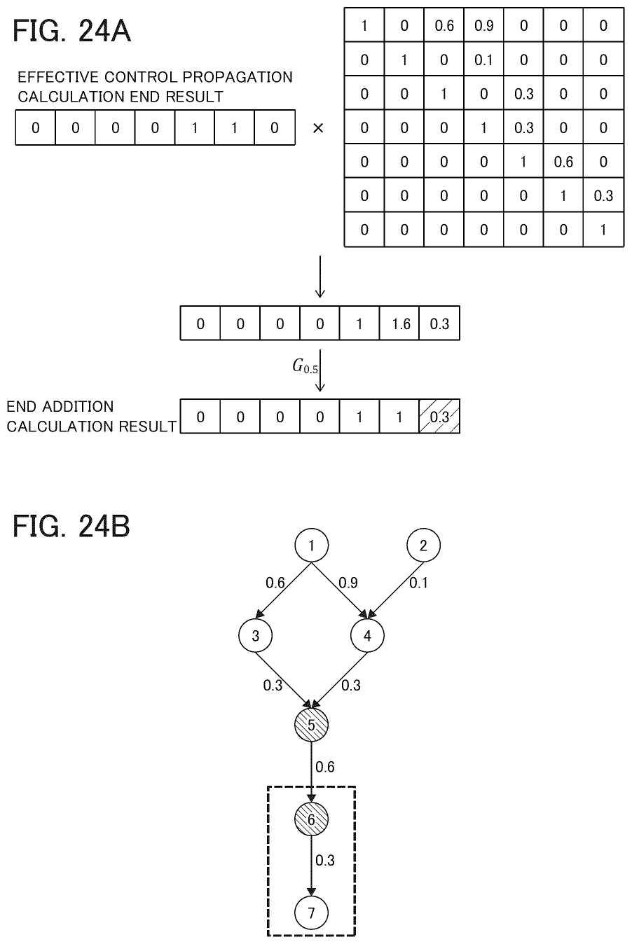

After the end of the vector update processing, at Step S307 in FIG. 24A, the controlling vector v=(0, 0, 0, 0, 1, 1, 0) at the end of the vector update processing is multiplied by the incidence matrix. A result of the multiplication, a row vector, holds (0, 0, 0, 0, 1, 1.6, 0,3). Furthermore, the second function G is applied to the row vector. As a result, o(i) is obtained to hold o(i)=(0, 0, 0, 0, 1, 1, 0.3).

A value of the sixth entry of o(i) is 1, which shows that an influence level of the node 5 on the node is 1 (a maximum value) and that the node 6 is a controlled node. Moreover, a value of a seventh entry of o(i) is 0.3. Hence, an influence level of the node 5 on the node 7 is 0.3. This reflects a connection relationship in the region surrounded by a broken line in FIG. 24B.

Hence, the processing for all the candidate nodes ends (Step S308: YES). The matrix operation illustrated in FIG. 16 ends.

Note that, when the processing is performed for the node 1, the node 5 is already seen as a controlled node effectively controlled by the node 1. Hence, the control relationship (see FIG. 23B) and the influence levels (see FIG. 24B) of the node 5 are included in the result of the processing for the node 1. Hence, the processing for the node 5 may be omitted.

### 2.7 Specific Example

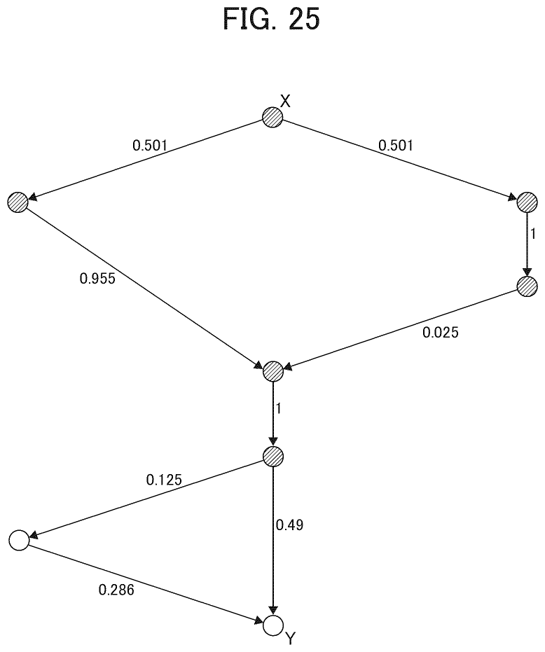

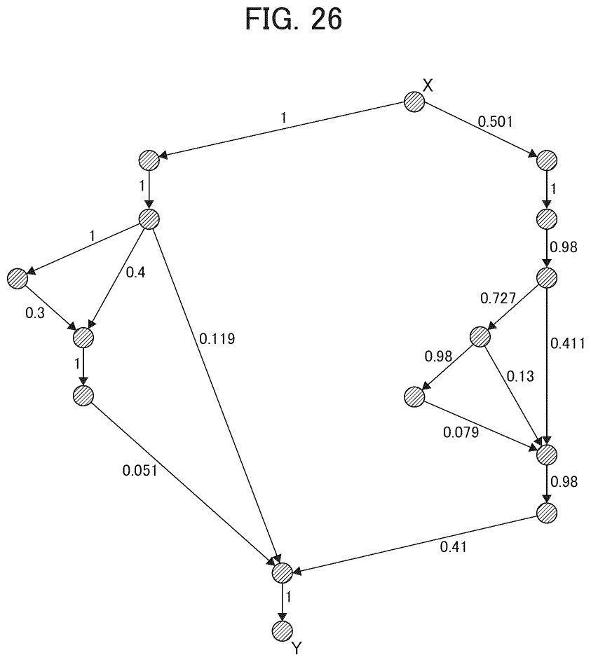

FIGS. 25 and 26 exemplify a result of processing performed when a node X is the controlling node and a node Y is the target node in a predetermined network. In the example illustrated in FIG. 25, if the index described above in this embodiment is used as an influence level of the node X on the node Y, a value of the index is 0.49. That is, the node X does not effectively control the node Y. Whereas, if POWER INDEX is used as the influence level, the value of the influence level of the node X on the node Y is 0.526. That is, in the network illustrated in FIG. 25, the value of POWER INDEX could be excessively large. However, the influence level of this embodiment can be set to a value appropriately reflecting the control relationship.

In the example illustrated in FIG. 26, if the index described above in this embodiment is used as an influence level of the node X on the node Y, a value of the index is 1. That is, the node X effectively controls the node Y. Whereas, if POWER INDEX is used as an influence level, the value of the influence level of the node X on the node Y is 0.428. That is, in the network illustrated in FIG. 26, the value of POWER INDEX could be excessively small. However, the influence level of this embodiment can be set to a value appropriately reflecting the control relationship. As can be seen, the technique of this embodiment can precisely obtain an influence level representing the control relationship.

This embodiment has been detailed as described above. A person skilled in the art will readily appreciate that many modifications are possible without substantially departing from the new matter and advantageous effects of this embodiment. Accordingly, all such modifications are included in the scope of the present disclosure. For instance, terms appeared at least once in the Specification or in the drawings along with other broader or synonymous terms can be replaced with the other broader or synonymous terms in any part of the Specification or the drawings. Further, all combinations of this embodiment and its modifications are encompassed in the scope of the present disclosure. Furthermore, the configurations and operations of the server system, the terminal device, and others are not limited to those described in this embodiment. Their modifications are possible in various manners.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing system, comprising:
an entity network obtaining unit configured to obtain an entity network representing a capital investment relationship between a plurality of nodes each corresponding to one of a plurality of entities, the entity network including a lower node receiving an investment and a higher node making an investment, and the lower node and the higher node being connected together with an edge provided with a capital contribution ratio; and
a controlled node identifying unit configured to identify, in accordance with the entity network, a controlled node that is a node to be effectively controlled by a controlling node among the plurality of nodes,
wherein, when the controlling node and the controlled node that has been identified are set as a first node group, the controlled node identifying unit performs update processing to identify the controlled node, the update processing adding, to the controlled node, a node included the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.

2. The information processing system according to claim 1,
wherein the controlled node identifying unit:
performs initialization processing to initialize the controlled node with an empty set;
performs, after the initialization processing, first update processing to add a node to the controlled node, the node being included in the plurality of nodes, being directly connected to the controlling node, and having the capital contribution ratio assigned to the edge between the node and the controlling node, and the capital contribution ratio being greater than the first threshold; and
repeatedly executes second update processing after the first update processing to identify the controlled node, the second update processing being the update processing.

3. The information processing system according to claim 2,
wherein, if the controlled node does not change even if the second update processing is performed, the controlled node identifying unit finishes the second update processing.

4. The information processing system according to claim 1, further comprising
an influence level calculating unit configured to obtain an influence level of the controlling node on an other node,
wherein, if a target node among the plurality of nodes is not included in the first node group after the processing to identify the controlled node ends, the influence level calculating unit obtains an influence level of the controlling node on the target node in accordance with the capital contribution ratio assigned to the edge directly connecting together the target node and a node included in the first node group.

5. The information processing system according to claim 4,
wherein the influence level calculating unit sets a maximum value for an influence level of the controlling node on the controlled node.

6. The information processing system according to claim 4,
wherein the influence level calculating unit identifies one or a plurality of edges directly connecting together the target node and any one or more nodes included in the first node group, and obtains a sum of the capital contribution ratios assigned to the identified one or plurality of edges as an influence level of the controlling node on the target node.

7. The information processing system according to claim 4,
wherein if the target node is not directedly connected to any of the nodes included in the first node group, the influence level calculating unit sets a minimum value for an influence level of the controlling node on the target node.

8. The information processing system according to claim 1, further comprising
a subnetwork extracting unit configured to extract a subnetwork including the higher node to be directly or indirectly connected to the target node, when any one of the plurality of nodes is determined as the target node,
wherein the controlled node identifying unit selects, as the controlling node, a node that is included in the subnetwork and other than the target node, the node having the capital contribution ratio to at least an other node, and the capital contribution ratio being higher than the first threshold.

9. The information processing system according to claim 1, further comprising
a display processing unit configured to display, in the entity network, the controlling node and the controlled node in a manner distinguishable from an other node.

10. The information processing system according to claim 1,
wherein, when first to N-th nodes are included in a subnetwork directly or indirectly connected to the controlling node in the entity network (N is an integer of 2 or more), the controlled node identifying unit obtains: an incidence matrix of N rows and N columns in which a value of an entry in row i (i is an integer of 1 or more and N or less) and column i is 1, and a value of an entry in row i and column j (j is an integer of 1 or more and N or less and different from i) is a value indicating the capital contribution ratio of an i-th node to a j-th node; and a controlling vector that is an N-dimensional vector in which an entry corresponding to the controlling node is set to 1 and entries corresponding to other nodes are set to 0, and
the controlled node identifying unit obtains the controlled node, using a product of the controlling vector and the incidence matrix.

11. The information processing system according to claim 10,
wherein, for each of the entries of an N-dimensional vector that is a product of the controlling vector and the incidence matrix, the controlled node identifying unit performs vector update processing to: perform processing to update a value of an entry greater than the first threshold to read a first value, and to update a value of an entry smaller than, or equal to, the first threshold to read a second value smaller than the first value; and update the controlling vector with the N-dimensional vector that has been processed, and
for the controlling vector after the vector update processing ends, the controlled node identifying unit identifies, as the controlled node, a node corresponding to an entry a value of which is the first value.

12. The information processing system according to claim 11, further comprising
an influence level calculating unit configured to: perform, for each of the entries of an N-dimensional vector that is the product of the controlling vector and the incidence matrix after the vector update processing ends, processing to update a value of an entry greater than the first threshold to read 1, and to maintain a value of an entry smaller than, or equal to, the first threshold; and obtain a value of each of the entries of the N-dimensional vector, which has been processed, as an influence level of the controlling node on each of the plurality of nodes.

13. A method for processing information performed by an information processing device, the method comprising:
obtaining an entity network representing a capital investment relationship between a plurality of nodes each corresponding to one of a plurality of entities, the entity network including a lower node receiving an investment and a higher node making an investment, and the lower node and the higher node being connected together with an edge provided with a capital contribution ratio; and
identifying, in accordance with the entity network, a controlled node that is a node to be effectively controlled by a controlling node among a plurality of nodes,
wherein, when the controlling node and the controlled node that has been identified are set as a first node group, the identifying the controlled node involves performing update processing to identify the controlled node, the update processing adding, to the controlled node, a node included in the plurality of nodes, directly connected to a second node group including one or a plurality of nodes included in the first node group, and having capital contribution ratios including the capital contribution ratio and each assigned to the edge between the node and each of the nodes of the second node group, and a sum of the capital contribution ratios being greater than a first threshold.
